(19) United States
(12) Patent Application Publication
(10) Pub. No.: US 2025/0157274 A1
(43) Pub. Date: May 15, 2025

(54) LATCH SYSTEM WITH WIRELESS NETWORKED ACCESS CONTROL

(71) Applicant: Southco, Inc., Concordville, PA (US)

(72) Inventors: Nicholas Paul Bennett, Worcester (GB); Robert Earl Moore, Odessa, FL (US); Ingobert Günter Stein, Worcester (GB); Neil Philip Swann, Bromsgrove (GB); Simon Neil Williamson, Herefordshire (GB)

(73) Assignee: Southco, Inc., Concordville, PA (US)

(21) Appl. No.: 18/580,948

(22) PCT Filed: Jul. 19, 2022
(86) PCT No.: PCT/US2022/037546

§ 371 Date: Jan. 19, 2024

Related U.S. Application Data
(60) Provisional application No. 63/224,310, filed on Jul. 21, 2021.

(51) Int. Cl. G07C 9/28; G06K 7/10; G07C 9/27; G07C 9/29

(52) U.S. Cl. CPC G07C 9/28; G06K 7/10316; G07C 9/27; G07C 9/29

(57) ABSTRACT

A wireless latch assembly comprises a latch for latching a secure space; a display configured to display information; a sensor port for coupling a sensor to the assembly and for receiving a signal corresponding to a condition associated with the secure space; a wireless transceiver for performing wireless communication with one or more wireless components external to the assembly; a processor coupled to the display and to the wireless transceiver for displaying information relating to operation of the assembly and the condition associated with the secure space, receiving a plurality of credentials relating to access to the secure space, detecting a user credential for access to the secure space, comparing the user credential to the plurality of credentials to determine when the user credential is valid, and enable operation of the latch to permit access to the secure space.

### CROSS-REFERENCE TO RELATED APPLICATIONS

This application claims priority to U.S. Provisional Patent Application No. 63/224,310, filed on Jul. 21, 2021, titled “LATCH SYSTEM WITH WIRELESS NETWORKED ACCESS CONTROL” the entirety of which is incorporated by reference herein for all purposes.

### FIELD OF THE INVENTION

The present invention relates to the field of latch systems configured for use with an enclosure such as, for example, a secure space in a clean environment.

### BACKGROUND OF THE INVENTION

Latch assemblies are relied on in many applications for securing items such as panels, doors, and doorframes together. For example, containers, cabinets, closets, drawers, compartments, other forms of enclosures, and the like may be secured with a latch. One type of latch assembly, for example, includes a rotary pawl or cam, which remains open until the pawl or cam impinges on a bolt or striker. In such latch assemblies, the relative displacement of the latch assembly with respect to the bolt or striker causes the rotary pawl or cam to rotate and capture the bolt or striker.

In many applications an electrically operated latch is desirable due to the need for remote or push-button entry, coded access, key-less access, or monitoring of access. For example, various latches for panel closures have been employed where one of the panels, such as a swinging door, drawer or the like, is to be fastened or secured to a stationary panel, doorframe, cabinet, or compartment body.

There remains a need for new latch assemblies, such as new rotary pawl or cam latch assemblies, that include the option of electrical operation having at least one of a simpler and more cost-effective design.

### SUMMARY OF THE INVENTION

One aspect of the present invention provides a wireless latch assembly comprising a latch configured for latching a secure space; a display, local to the latch, configured to display information; a sensor port positioned for coupling a sensor to the wireless latch assembly and configured for receiving a signal corresponding to a condition associated with the secure space; a wireless transceiver configured for performing wireless communication with one or more wireless components external to the wireless latch assembly; a processor coupled to the display and to the wireless transceiver, the processor being configured to: display, via the display, information relating to operation of the wireless latch assembly and the condition associated with the secure space, receive, via the wireless transceiver, a plurality of credentials relating to access to the secure space, detect, via the wireless transceiver, a user credential of a user requesting access to the secure space, compare the user credential of the user to the plurality of credentials to determine when the user credential is valid, and enable operation of the latch to permit access to the secure space when it is determined that the user credential is valid.

In another aspect of the invention, a wireless latch system comprises: a server; a communication hub configured for communication with the server; an administrator computer configured for communication with the communication hub; and at least one wireless latch assembly including: a latch configured for latching a secure space, a display, local to the latch, configured to display information, a sensor port positioned for coupling a sensor to the wireless latch assembly and configured for receiving a signal corresponding to a condition associated with the secure space, a wireless transceiver configured for performing wireless communication with one or more wireless components external to the wireless latch assembly, and a processor coupled to the display and to the wireless transceiver, the processor being configured for controlling the wireless latch; wherein the administrator computer is configured to transmit to the server a plurality of credentials and a latch identification corresponding to the at least one wireless latch assembly, the plurality of credentials relating to access of the secure space secured by the at least one wireless latch assembly; wherein the server is configured to store the plurality of credentials and communicate the plurality of credentials and the latch identification to the communication hub; wherein the communication hub is configured to push the plurality of credentials to the at least one wireless latch assembly that corresponds to the latch identification; wherein the processor of the wireless latch assembly is configured to: display, via the display, information relating to operation of the wireless latch assembly and information relating to the condition associated with the secure space, receive, via the wireless transceiver, the plurality of credentials, detect, via the wireless transceiver, a user credential of the user requesting access to the secure space, compare the user credential of the user to the plurality of credentials to determine when the user credential is valid, and enable operation of the latch to unlock the secure space when it is determined that the user credential is valid.

In yet another aspect of the present invention, a latch assembly configured for mounting to an enclosure securing a secure space is disclosed, the latch assembly comprising: a housing; an actuator mounted for movement relative to the housing; a latch coupled to the actuator and movable between a latched condition and an unlatched condition; a slide movable relative to the housing between a retracted position and an extended position, the slide being configured for engagement with the actuator in the extended position and being configured for disengagement from the actuator in the retracted position, the slide including a locking pin positioned for engagement by a locking groove of the actuator when the slide is in the extended position and for disengagement from the locking groove of the actuator when the slide is in the retracted position; a biasing spring operating on the slide to bias the slide toward the extended position; a drive cam mounted for rotation relative to the housing and adjacent the slide, the drive cam being configured to move the slide against the biasing spring operation and toward the retracted position; wherein when the locking pin is engaged by the locking groove, the locking pin is in a fixed position relative to the actuator, and the locking pin and the actuator together prevent access to the secure area.

In yet another aspect of the present invention, a latch assembly configured to be fixed to a panel having a thickness selected from a range of thicknesses is disclosed, the latch assembly comprising: a pawl assembly configured to be positioned on a side of the panel, the pawl assembly comprising a pawl that is movable between locked and unlocked positions; an actuator configured to be positioned on an opposite side of the panel relative to the pawl assembly; a drive shaft configured to couple the actuator to the pawl assembly such that rotation of the drive shaft by the actuator moves the pawl between the locked and unlocked positions; a sleeve nut configured to be positioned on the side of the panel and defining an aperture extending along a sleeve nut axis for engagement from the opposite side of the panel on which the actuator is positioned, the sleeve nut having a flanged portion extending radially outwardly from the sleeve nut axis, the flanged portion being offset along the sleeve nut axis such that a first distance from the flanged portion to an actuator-facing end of the sleeve nut in a first orientation of the sleeve nut is smaller than a second distance from the flanged portion to an actuator-facing end of the sleeve nut in a second orientation of the sleeve nut; the sleeve nut being configured for engagement from the opposite side of the panel on which the actuator is positioned when the sleeve nut is in the first orientation or in the second orientation; and the latch assembly being configured to be fixed to a panel having a greater thickness when the sleeve nut is in the second orientation relative to when the sleeve nut is in the first orientation.

In yet another aspect of the present invention, a latch assembly configured for mounting to an enclosure defining a secure space in a clean environment is disclosed, the latch assembly comprising: a housing configured to be positioned adjacent an exterior surface of the enclosure, a sensor port associated with the housing, positioned for coupling a sensor to the latch assembly, and configured for receiving a signal corresponding to a condition associated with the secure space; a display associated with the housing for displaying information relating to the condition associated with the secure space; and a translucent protective cover positioned to cover the display; wherein the housing defines a display-receiving recess configured to receive the display and a cover-receiving recess configured to receive the translucent protective cover, thereby enclosing the display, the translucent protective cover being sealed to the housing to resist ingress of unwanted materials into the housing; and wherein the translucent protective cover has a thickness corresponding to a depth of the cover-receiving recess such that a cover exterior surface of the translucent protective cover is substantially flush with a housing exterior surface of the housing to reduce collection of unwanted materials and to facilitate removal of unwanted materials from the housing exterior surface, the translucent protective cover and the housing exterior surface together inhibiting the ingress of unwanted materials into the housing.

In yet another aspect of the present invention, a latch assembly configured for use with an enclosure having a panel and a frame and for latching the panel relative to the frame, the panel or the frame including a magnetized striker is disclosed, the latch assembly comprising: a latch configured for mounting to the panel or the frame in multiple predetermined orientations relative to the striker mounted on the other one of the panel or the frame; a sleeve coupled to the latch, the sleeve having an annular portion; a flexible substrate circumscribing the annular portion of the sleeve; sensors mounted on the flexible substrate, each of the sensors being positioned adjacent the annular portion of the sleeve at different radial locations, each of the sensors configured to detect the striker when the sensor is proximal to the striker, and one of the sensors mounted on the flexible substrate being positioned to detect the striker in each of the predetermined orientations of the latch.

In yet another aspect of the present invention, a latch assembly configured for mounting to an enclosure defining a secure space is disclosed, the latch assembly comprising: a housing configured to be positioned adjacent an exterior surface of the enclosure in one of multiple orientations; a pawl assembly coupled to an actuator and comprising a pawl that is movable between locked and unlocked positions, the pawl being positionable in one of multiple pawl orientations depending on the orientation of the housing; an actuator movable relative to the housing and coupled for actuation of the pawl assembly; a display associated with the housing for displaying information relating to operation of the latch assembly, the information including status information and a placement instruction located in a position indicative of placement of a user credential relative to the display, the display being configured to reorient the status information relative to the housing depending on the orientation of the housing, and the display being configured to maintain the position of the placement instruction relative to the housing independent of the orientation of the housing.

### BRIEF DESCRIPTION OF THE DRAWINGS

FIG. 1 is a block diagram of a wireless latch according to an embodiment of the invention.

FIG. 2A is a block diagram of a wireless latch system according to an embodiment of the invention.

FIG. 2B is a block diagram of a wireless latch system according to an embodiment of the invention.

FIG. 3A shows an implementation of the wireless latch on a mobile cart mounted cabinet according to an embodiment of the invention.

FIG. 3B shows an implementation of the wireless latch on a wall mounted cabinet according to an embodiment of the invention.

FIG. 3C is a block diagram of a wireless latch system implemented in a hospital according to an embodiment of the invention.

FIG. 4A is a diagram of a first workflow scenario for the wireless latch system according to an embodiment of the invention.

FIG. 4B is another diagram of the first workflow scenario for the wireless latch system according to an embodiment of the invention.

FIG. 4C is another diagram of the first workflow scenario for the wireless latch system according to an embodiment of the invention.

FIG. 4D is another diagram of the first workflow scenario for the wireless latch system according to an embodiment of the invention.

FIG. 5A is a diagram of a second workflow scenario for the wireless latch system according to an embodiment of the invention.

FIG. 5B is another diagram of the second workflow scenario for the wireless latch system according to an embodiment of the invention.

FIG. 5C is another diagram of the second workflow scenario for the wireless latch system according to an embodiment of the invention.

FIG. 6A is a diagram of a third workflow scenario for the wireless latch system according to an embodiment of the invention.

FIG. 6B is another diagram of the third workflow scenario for the wireless latch system according to an embodiment of the invention.

FIG. 6C is another diagram of the third workflow scenario for the wireless latch system according to an embodiment of the invention.

FIG. 6D is another diagram of the third workflow scenario for the wireless latch system according to an embodiment of the invention.

FIG. 7A is a diagram of a fourth workflow scenario for the wireless latch system according to an embodiment of the invention.

FIG. 7B is another diagram of the fourth workflow scenario for the wireless latch system according to an embodiment of the invention.

FIG. 7C is another diagram of the fourth workflow scenario for the wireless latch system according to an embodiment of the invention.

FIG. 7D is another diagram of the fourth workflow scenario for the wireless latch system according to an embodiment of the invention.

FIG. 8 is diagram of additional implementations for the wireless latch system according to an embodiment of the invention.

FIG. 9A shows a side view of an embodiment of a latch assembly.

FIG. 9B shows a rear view of the latch assembly of FIG. 9A.

FIGS. 9C-9D show partially exploded views of the latch assembly of FIG. 9A.

FIG. 10 shows an exploded view of an embodiment of the latch assembly, showing an actuator assembly, a battery box assembly, and a pawl assembly.

FIG. 11 shows an exploded view of an embodiment of a driver subassembly of the actuator assembly.

FIGS. 12A-12C show views of an embodiment of a driver housing.

FIGS. 13A-13C show views of an embodiment of a driver.

FIGS. 14A-14B show views of an embodiment of a handle.

FIG. 15 shows an exploded view of an embodiment of a base subassembly of the actuator assembly.

FIGS. 16A-16F show views of an embodiment of a slide.

FIGS. 17A-17D show views of an embodiment of a drive cam.

FIGS. 18A-18C show views of an embodiment of a motor.

FIGS. 19A-19C show views of an embodiment of a circuit board including a processor.

FIG. 20 shows an exploded view of an embodiment of the battery box assembly.

FIG. 21 shows an exploded view of an embodiment of the pawl assembly.

FIGS. 22A-22C show views of the pawl assembly of FIG. 21.

FIGS. 23A-23B show views of an embodiment of a slam latch body.

FIGS. 24A-24B show views of an embodiment of a bushing.

FIGS. 25A-25C show views of an embodiment of a drive shaft.

FIGS. 26A-26C show views of an embodiment of a pawl.

FIGS. 27A-27B show views of an embodiment of a sleeve.

FIGS. 28A-28B show views of an embodiment of the latch assembly, showing an embodiment of a panel having a thickness selected from a range of thicknesses.

FIGS. 28C-28D show cross-section views of FIGS. 28A and 28B, respectively.

FIGS. 28E-28F show detailed views of a portion of FIGS. 28C and 28D, respectively.

FIGS. 29A-29D show views of an embodiment of a sleeve nut.

FIG. 30 shows an exploded view of an embodiment of a bezel sub assembly of the actuator assembly.

FIGS. 31A-31C show views of an embodiment of a bezel.

FIGS. 32A-32C show views of an embodiment of a flexible printed circuit board.

FIGS. 33A-33D show views of an embodiment of the latch assembly, showing an embodiment having the flexible printed circuit board wrapped around the sleeve.

### DETAILED DESCRIPTION OF THE INVENTION

The invention will now be described by reference to exemplary embodiments and variations of those embodiments. Although the invention is illustrated and described herein with reference to specific embodiments, the invention is not intended to be limited to the details shown and described. Rather, various modifications may be made in the details within the scope and range of equivalents of the claims and without departing from the invention.

### Wireless Latch and Network Description

As will be described in greater detail below, this invention makes it possible to use a wireless network access control system to replace physical keys used to control and manage access to substances, e.g. drugs, in a secure facility or clean environment, e.g. a hospital. In one non-limiting example selected for illustration, a latch system according to aspects of this invention can be used to selectively latch and unlatch an enclosure for access to an interior of a secure space, such as drug cabinets and drug trollies, having a latchable door or panel that secures contents and that is opened and closed frequently by authorized personnel.

Referring generally to the figures, a wireless latch assembly comprises a latch 100 configured for latching a secure space; a display 102, local to the latch 100, configured to display information; a sensor port 118 positioned for coupling a sensor 120 to the wireless latch assembly and configured for receiving a signal corresponding to a condition associated with the secure space; a wireless transceiver 108 configured for performing wireless communication with one or more wireless components external to the wireless latch assembly; a processor 1066 coupled to the display 102 and to the wireless transceiver 108, the processor 1066 being configured to: display, via the display 102, information relating to operation of the wireless latch assembly and the condition associated with the secure space, receive, via the wireless transceiver 108, a plurality of credentials relating to access to the secure space, detect, via the wireless transceiver 108, a user credential 206C of a user requesting access to the secure space, compare the user credential 206C of the user to the plurality of credentials to determine when the user credential 206C is valid, and enable operation of the latch 100 to permit access to the secure space when it is determined that the user credential 206C is valid.

Still referring generally to the figures, a wireless latch system comprises a server 206A; a communication hub 204A configured for communication with the server 206A; an administrator computer 206B configured for communication with the communication hub 204A; and at least one wireless latch assembly including: a latch 100 configured for latching a secure space, a display 102, local to the latch 100, configured to display information, a sensor port 118 positioned for coupling a sensor 120 to the wireless latch assembly and configured for receiving a signal corresponding to a condition associated with the secure space, a wireless transceiver 108 configured for performing wireless communication with one or more wireless components external to the wireless latch assembly, and a processor 1066 coupled to the display 102 and to the wireless transceiver 108, the processor 1066 being configured for controlling the wireless latch 100; wherein the administrator computer 206B is configured to transmit to the server 206A a plurality of credentials and a latch identification corresponding to the at least one wireless latch assembly, the plurality of credentials relating to access of the secure space secured by the at least one wireless latch assembly; wherein the server 206A is configured to store the plurality of credentials and communicate the plurality of credentials and the latch identification to the communication hub 204A; wherein the communication hub 204A is configured to push the plurality of credentials to the at least one wireless latch assembly that corresponds to the latch identification; wherein the processor 1066 of the wireless latch assembly is configured to: display, via the display 102, information relating to operation of the wireless latch assembly and information relating to the condition associated with the secure space, receive, via the wireless transceiver 108, the plurality of credentials, detect, via the wireless transceiver 108, a user credential 206C of the user requesting access to the secure space, compare the user credential 206C of the user to the plurality of credentials to determine when the user credential 206C is valid, and enable operation of the latch 100 to unlock the secure space when it is determined that the user credential 206C is valid.

Referring generally to the figures, a latch assembly 1000 configured for mounting to an enclosure securing a secure space is disclosed. The latch assembly 1000 comprises a housing 1002; an actuator 1014 mounted for movement relative to the housing 1002; a latch 1006 coupled to the actuator 1014 and movable between a latched condition and an unlatched condition; a slide 1028 movable relative to the housing 1002 between a retracted position and an extended position, the slide 1028 being configured for engagement with the actuator 1014 in the extended position and being configured for disengagement from the actuator 1014 in the retracted position, the slide 1028 including a locking pin 1046 positioned for engagement by a locking groove 1030 of the actuator 1014 when the slide 1028 is in the extended position and for disengagement from the locking groove 1030 of the actuator 1014 when the slide 1028 is in the retracted position; a biasing spring 1050 operating on the slide 1028 to bias the slide 1028 toward the extended position; a drive cam 1052 mounted for rotation relative to the housing 1002 and adjacent the slide 1028, the drive cam 1052 being configured to move the slide 1028 against the biasing spring operation and toward the retracted position; wherein when the locking pin 1046 is engaged by the locking groove 1030, the locking pin 1046 is in a fixed position relative to the actuator 1014, and the locking pin 1046 and the actuator 1014 together prevent access to the secure area.

A latch assembly 2000 configured to be fixed to a panel 1082 having a thickness selected from a range of thicknesses is disclosed. The latch assembly 2000 comprises a pawl assembly 1006 configured to be positioned on a side of the panel 1082, the pawl assembly 1006 comprising a pawl 1120 that is movable between locked and unlocked positions; an actuator 1014 configured to be positioned on an opposite side of the panel 1082 relative to the pawl assembly 1006; a drive shaft 1140 configured to couple the actuator 1014 to the pawl assembly 1006, such that rotation of the drive shaft 1140 by the actuator 1014 moves the pawl 1120 between the locked and unlocked positions; a sleeve nut 1024 configured to be positioned on the side of the panel 1082 and defining an aperture 2002 extending along a sleeve nut axis for engagement from the opposite side of the panel 1082 on which the actuator 1014 is positioned, the sleeve nut 1024 having a flanged portion 2004 extending radially outwardly from the sleeve nut axis, the flanged portion 2004 being offset along the sleeve nut axis such that a first distance from the flanged portion 2004 to an actuator-facing end 2006 of the sleeve nut 1024 in a first orientation of the sleeve nut 1024 is smaller than a second distance from the flanged portion 2004 to an actuator-facing end 2006 of the sleeve nut 1024 in a second orientation of the sleeve nut 1024; the sleeve nut 1024 being configured for engagement from the opposite side of the panel 1082 on which the actuator 1014 is positioned when the sleeve nut 1024 is in the first orientation or in the second orientation; and the latch assembly 2000 being configured to be fixed to a panel 1082 having a greater thickness when the sleeve nut 1024 is in the second orientation relative to when the sleeve nut 1024 is in the first orientation.

A latch assembly 3000 configured for mounting to an enclosure defining a secure space in a clean environment is disclosed. The latch assembly 3000 comprises a housing 1002 configured to be positioned adjacent an exterior surface of the enclosure, a sensor port 118 associated with the housing 1002, positioned for coupling a sensor 120 to the latch assembly 3000, and configured for receiving a signal corresponding to a condition associated with the secure space; a display 102 associated with the housing 1002 for displaying information relating to the condition associated with the secure space; and a translucent protective cover 3008 positioned to cover the display 102; wherein the housing 1002 defines a display-receiving recess 3006 configured to receive the display 102 and a cover-receiving recess 3010 configured to receive the translucent protective cover 3008, thereby enclosing the display 102, the translucent protective cover 3008 being sealed to the housing 1002 to resist ingress of unwanted materials into the housing 1002; and wherein the translucent protective cover 3008 has a thickness corresponding to a depth of the cover-receiving recess 3010 such that a cover exterior surface 3012 of the translucent protective cover 3008 is substantially flush with a housing exterior surface 3014 of the housing 1002 to reduce collection of unwanted materials and to facilitate removal of unwanted materials from the housing exterior surface 3014, the translucent protective cover 3008 and the housing exterior surface 3014 together inhibiting the ingress of unwanted materials into the housing 1002.

A latch assembly 4000 configured for use with an enclosure having a panel 1082 and a frame and for latching the panel 1082 relative to the frame, the panel 1082 or the frame including a magnetized striker is disclosed. The latch assembly 4000 comprises a latch 1006 configured for mounting to the panel 1082 or the frame in multiple predetermined orientations relative to the striker mounted on the other one of the panel 1082 or the frame; a sleeve 1126 coupled to the latch 1006, the sleeve 1126 having an annular portion 4002; a flexible substrate 1100 circumscribing the annular portion 4002 of the sleeve 1126; sensors 4004 mounted on the flexible substrate 1100, each of the sensors 4004 being positioned adjacent the annular portion 4002 of the sleeve 1126 at different radial locations, each of the sensors 4004 configured to detect the striker when the sensor 4004 is proximal to the striker, and one of the sensors 4004 mounted on the flexible substrate being positioned to detect the striker in each of the predetermined orientations of the latch 1006.

A latch assembly 3000/4000 may further be configured for mounting to an enclosure defining a secure space. The latch assembly 3000/4000 comprises a housing 1002 configured to be positioned adjacent an exterior surface of the enclosure in one of multiple orientations; a pawl assembly 1006 coupled to an actuator 1014 and comprising a pawl 1120 that is movable between locked and unlocked positions, the pawl 1120 being positionable in one of multiple pawl orientations depending on the orientation of the housing 1002; an actuator 1014 movable relative to the housing 1002 and coupled for actuation of the pawl assembly 1006; a display 102 associated with the housing 1002 for displaying information relating to operation of the latch assembly 3000/4000, the information including status information and a placement instruction located in a position indicative of placement of a user credential 206C relative to the display 102, the display 102 being configured to reorient the status information relative to the housing 1002 depending on the orientation of the housing 1002, and the display 102 being configured to maintain the position of the placement instruction relative to the housing 1002 independent of the orientation of the housing 1002.

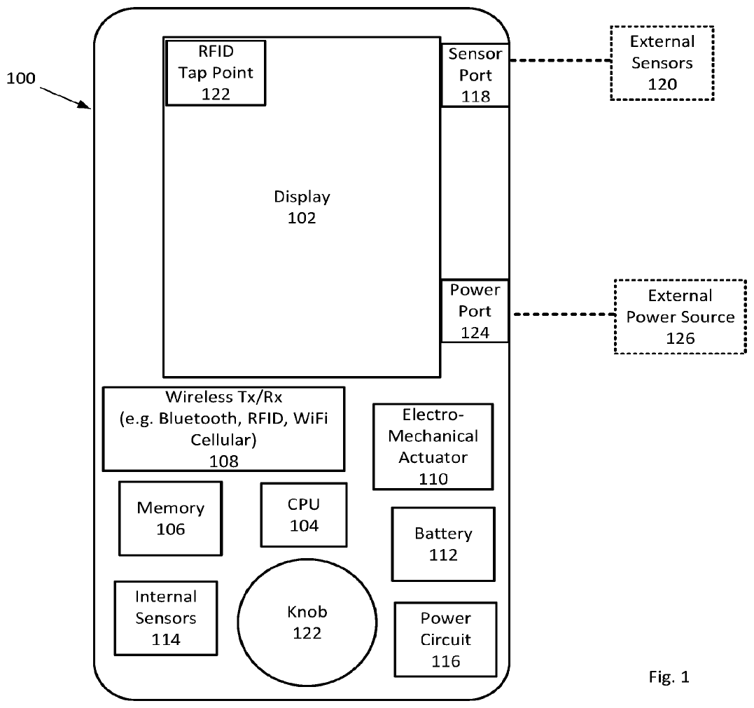

More specifically, and referring particularly to figures illustrating embodiments of this invention, this invention provides a wireless latch 100 (see FIG. 1) that includes CPU 104 for controlling various components within the wireless latch 100, display 102 (e.g. LCD, LED, etc.) for displaying information to the user of the wireless latch 100, memory 106 (e.g. RAM, ROM, etc.) for storing data for the CPU, wireless transceiver 108 (e.g. Bluetooth®, WiFi, RFID, Cellular, etc.) for wirelessly communicating with external devices, electro-mechanical actuator 110 (e.g. solenoid, motor, etc.) for actuating the latch (e.g. retracting/extending the pawl), battery 112 (e.g. rechargeable, replaceable, etc.) for powering the wireless latch 100, power circuit 116 (e.g. charging circuit, voltage regulator, etc.) for charging the battery from external source 126 via power port 124 (e.g. micro-USB) and supplying conditioned voltage to the components of the wireless latch 100, internal sensors (e.g. accelerometer) for detecting movement and orientation of wireless latch 100, external sensors 120 for measuring physical parameters (e.g. temperature, humidity, vibration, etc.) in or associated with the container/room that is being secured by the latch, sensor port 118 for connecting the external sensors to the wireless latch 100, RFID tap point 122 for tapping or interaction with an RFID card, and knob (e.g. rotatable, lever, etc.) for providing user interface to the wireless latch. It is noted that the specific electrical interconnections between these components are not expressly shown in FIG. 1 for the sake of clarity. Such electrical interconnections would be apparent to those skilled in the art.

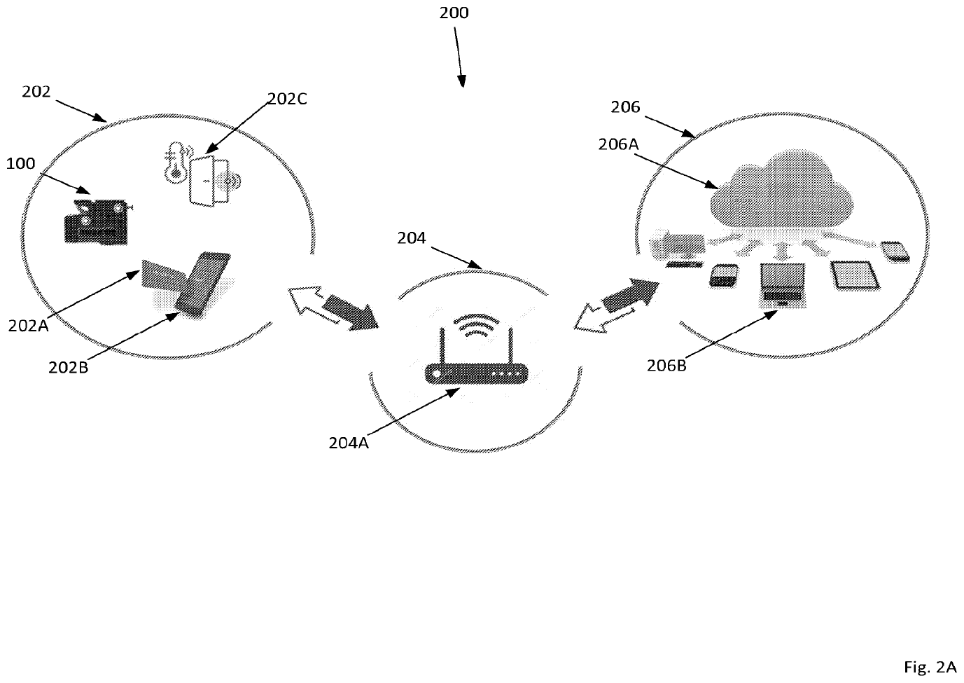

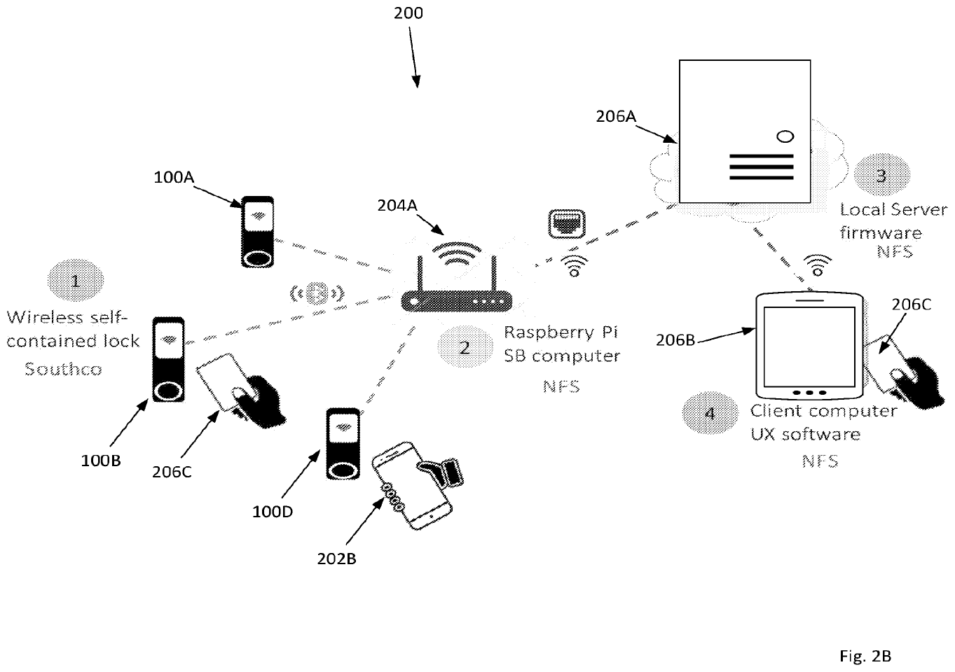

Wireless latch 100 in FIG. 1 is part of a wireless network 200 shown in FIG. 2A. More specifically, wireless network 200 includes a frontend system 202 that includes wireless latch 100 for securing container/room 202C, RFID card 202A and/or smart device 202B for acting as a key for wireless latch 100. Wireless network 200 also includes a backend system 206 including server 206A for storing latch credentials and audit trails of user access, and administrator device 206B (e.g. PC, smart device, etc.) for providing a means to manage latch credentials, audit trails and other parameters. Wireless network 200 also includes a middle-man system 204 including communication HUB 204A for interfacing the front end system 202 with the back end system 206.

An example of wireless network 200 in FIG. 2A is shown in FIG. 2B. In this example, frontend system 202 includes multiple wireless latches 100A, 100B, and 100D for securing respective containers/rooms (not shown). These wireless latches 100A, 100B, and 100D are accessed by either mobile phone 202B or RFID card 206C. Furthermore, wireless latches 100A, 100B, and 100D are in wireless communication with wireless HUB 204A (e.g. a Raspberry Pi®) which services all of the wireless latches 100A, 100B, and 100D. Wireless HUB 204A communicates with backend server 206A, which is in communication with client (e.g. administrator) computer 206B. Generally, during operation, the administrator matches certain user credentials (e.g. RFID cards 206C) to certain latches using a software application executing on administrator computer 206B.

In one example, an RFID card 206C is tapped against the screen of computer 206B which has an RFID reader/writer. Computer 206B reads the RFID of the card 206C and assigns the RFID to one or more the latches. In another example, mobile phone 202B communicates wirelessly (e.g. via Bluetooth®) with computer 206B. Computer 206B reads ID (e.g. MAC address) of mobile phone 202B and assigns the RFID to one or more the latches. Generally, these matched credentials are sent to backend server 206A for storage. The credentials may also be pushed from the backend server 206A to the corresponding matching latches 100A-100D.

In one example (where the matched credentials are stored in the backend server), when a user attempts to open one of wireless latches 100A-100D, the ID of their mobile phone 202B or RFID card 206C is detected by the corresponding wireless latch, transmitted to wireless HUB 204A along with the latch ID and then relayed to backend server 206A. If backend server 206A determines that the mobile phone 202B or RFID card 206C matches the latch ID, an unlock instruction is sent from backend server 206A to the corresponding wireless latch via wireless HUB 204A. This instruction controls the latch to retract the pawl.

In another example (where the credentials pushed from the backend server 206A to the matched wireless latch), when a user attempts to open wireless latch, the ID of their mobile phone 202B or RFID card 206C is detected by the matched wireless latch, and compared to the credentials. If the matched wireless latch determines that the mobile phone 202B or RFID card 206C matches the stored credentials, then the matched wireless latch issues an unlock instruction and controls the actuator to retract the pawl. In this example, the backend server 206A does not need to be involved.

### Medical Use Cases

Needless to say, wireless latch 100 can be used to secure any space including but not limited to rooms, containers, and vehicles. Wireless latch 100 can be mounted to any barrier including but not limited to doors and drawers. For example, wireless latch 100 has applicability in the medical field for securing medications and medical equipment.

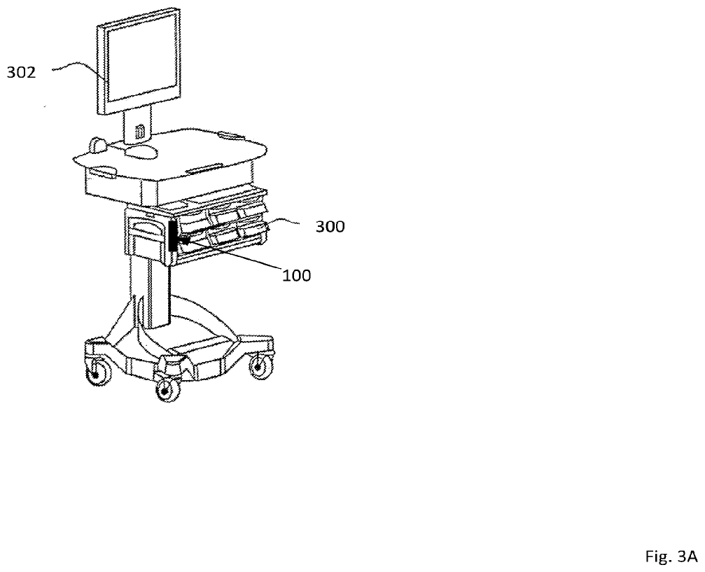

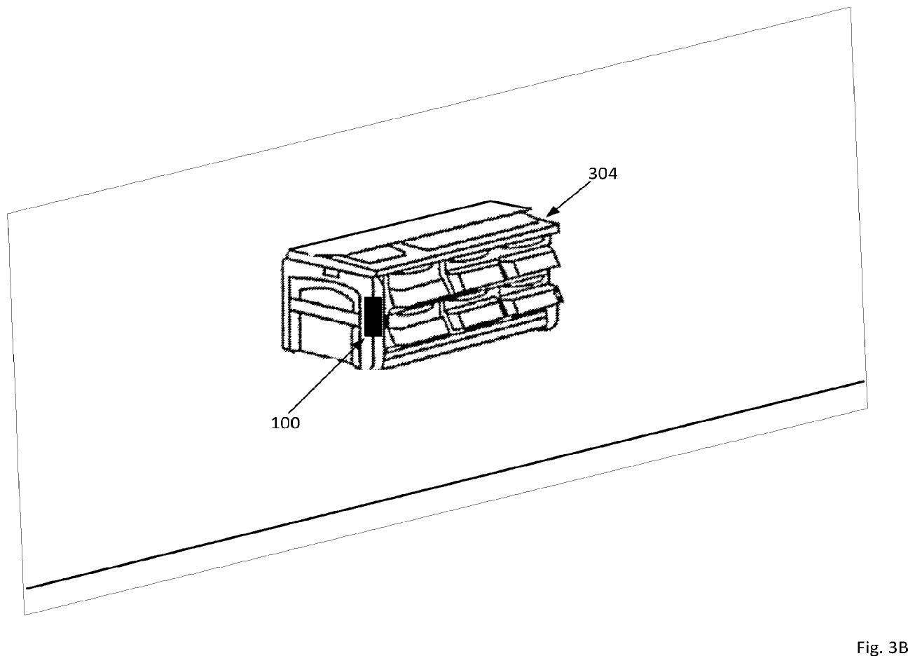

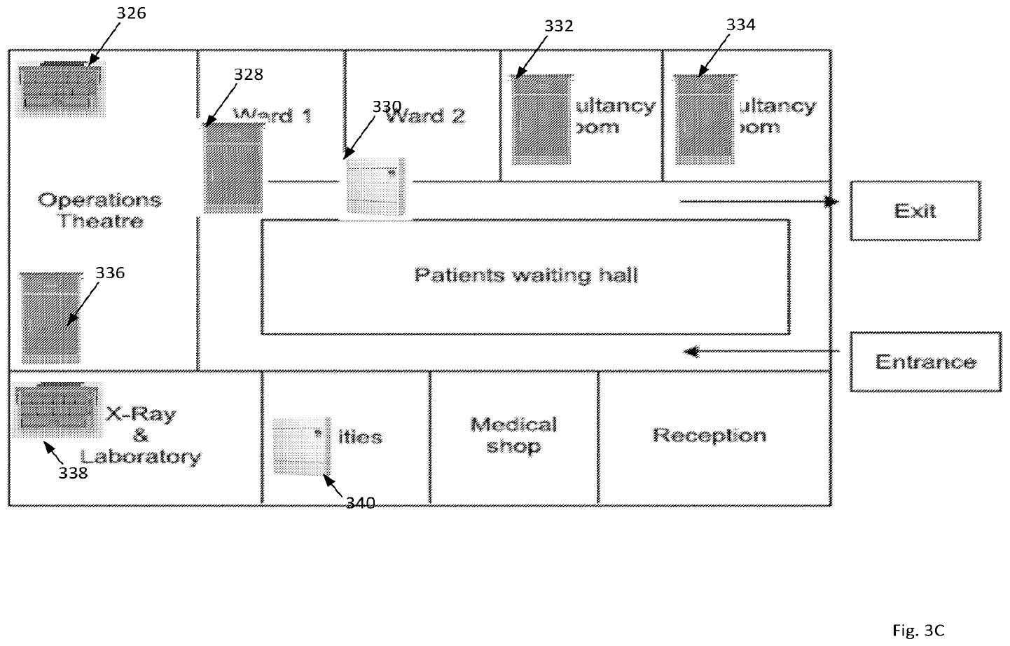

In one example, as shown in FIG. 3A, wireless latch 100 may be mounted to healthcare provider mobile cart 100 that includes various drawers for storing medications and medical equipment. The mobile cart may be pushed through a medical facility (e.g. hospital) between patient rooms for administering medications to patients. Wireless latch 100 may be configured to latch one or more the drawers to prevent unauthorized access to medications.

During operation, the healthcare professional (e.g. nurse) may use their mobile phone or RFID card (not shown) to interact with wireless latch 100. For example, the ID of mobile device or RFID card may be detected by wireless latch 100, sent to a HUB (not shown) or to OEM computer 302 which acts as the communication HUB to send the user ID and latch ID to network server (not shown). If the user ID is determined to be a valid credential for the given latch, the network server sends an unlock command to wireless latch 100 via the HUB or via OEM computer.

It is noted that in the healthcare environment, other containers may be secured with wireless latch 100. For example, a wall mounted medication container may be equipped with wireless latch 100 as shown in FIG. 3B. Other containers (not shown) including intensive care pharmacy wall and floor cabinets, acute medical trolley patient bedside lockers, fixed refrigerated cabinets and fixed lockers for pharmacy goods or staff personal may also be secured by wireless latch 100.

An example of such a configuration is shown in FIG. 3C where various containers (medication dispensers, wall mounted and cart mounted devices, etc.) 326, 328, 330, 332, 334, 336, 338 and 340 located throughout the medical facility are fitted and secured with their own wireless latch 100. The wireless latches on these containers are in communication with the communication HUB (not shown in this figure) which is in communication with backend server (not shown in this figure). Each latch is therefore individually and independently controllable based on authorized user credentials.

Each latch optionally includes an accelerometer that determines orientation of the latch. This may be important in some applications, because the latch may be installed in different orientations (up, down, left and right) depending on the configuration of the container and pawl. By including an accelerometer, the latch is able to determine its orientation and adjust the orientation of the data displayed on display screen 102.

In addition, external sensors compatible with these wireless latches may be used to monitor physical or environmental parameters such as temperature and humidity of the medication in the containers. This is beneficial for containers that hold medications. Ensuring proper temperature and humidity within the container/room (especially refrigerated containers/rooms) may be important to ensuring the shelf life of a medication.

In these examples, external sensors may be electrically connected to the wireless latch via port 118 and then inserted into the container via the door or via a specialized measurement port in the container (not shown). This sensor information (e.g. temperature/humidity readings over time) may sent to the administrator via the HUB and server. Alerts (e.g. temperature/humidity outside of allowable ranges) may also be sent from the latch to the administrator via the HUB and server.

### Workflow Examples

Wireless latch device 100 described above can be configured to provide customers (administrators and users alike) with flexible configurable functionality for providing secure authorization to secure areas. In connected areas where wireless communication is possible, this functionality is supported by interaction with HUB 404 and server 402. In remote areas where wireless communication is not possible, this functionality could be performed solely by wireless latch device 100. In a remote area, for example, wireless latch device 100 could be pre-programed with a list of credentials, internal calendar and sensor measurement thresholds that allow wireless latch device 100 to be self-sufficient in authenticating users, providing access to secure areas and monitoring physical parameters of the secure areas.

In addition, customers (e.g. administrators) have the flexibility of configuring wireless latch device 100 to implement “White Lists” of authorized users, and/or implement “Black Lists” of unauthorized users, require single source authentication (e.g. smart phone or RFID card) and/or dual source authentication (e.g. smart phone and RFID card) and allow wireless latch device 100 to interact with and reprogram user devices (e.g. change RFID numbers, etc.). These instructions can be wirelessly pushed to one or more wireless latch devices that may or may not be a member of a common authorization group (e.g. group ID) via HUB 404. This allows wireless latch device 100 to collaborate with server 402 via HUB 404 in connected areas, while still allowing wireless latch device 100 to operate in a self-sufficient in remote areas. The dual source authentication could include the wireless latch device 100 reading an RFID from an RFID card of the user and if the RFID is authorized, wireless latch device 100 could push a request to the user's mobile device. If the user confirms the request via their mobile phone, the latch is unlocked.

Wireless latch system 200 can also keep logs (e.g. audit trails) of successful and unsuccessful attempts to open wireless latch device 100. Such audit trails may be useful to administrators when reviewing employee activity (e.g. employee shift hours, employee location in a facility, employee access to medication, etc.).

Four workflow examples of the functionality and operation of wireless latch system 200 are described below. These are examples and are not exhaustive of the application and functionality of wireless latch device 100.

### Workflow Example A (Black List RFID)

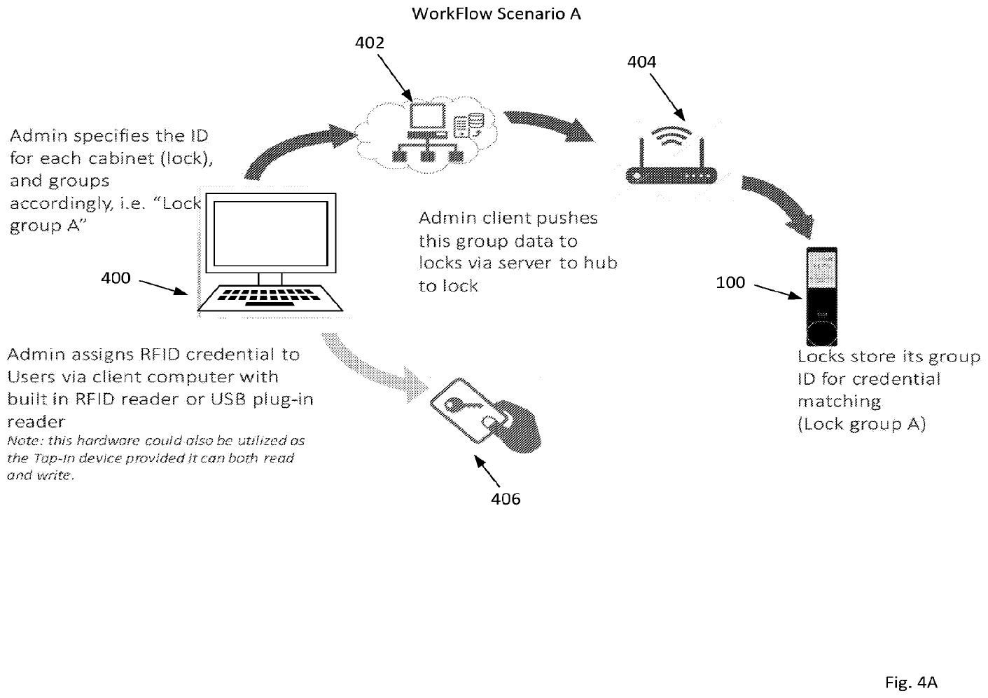

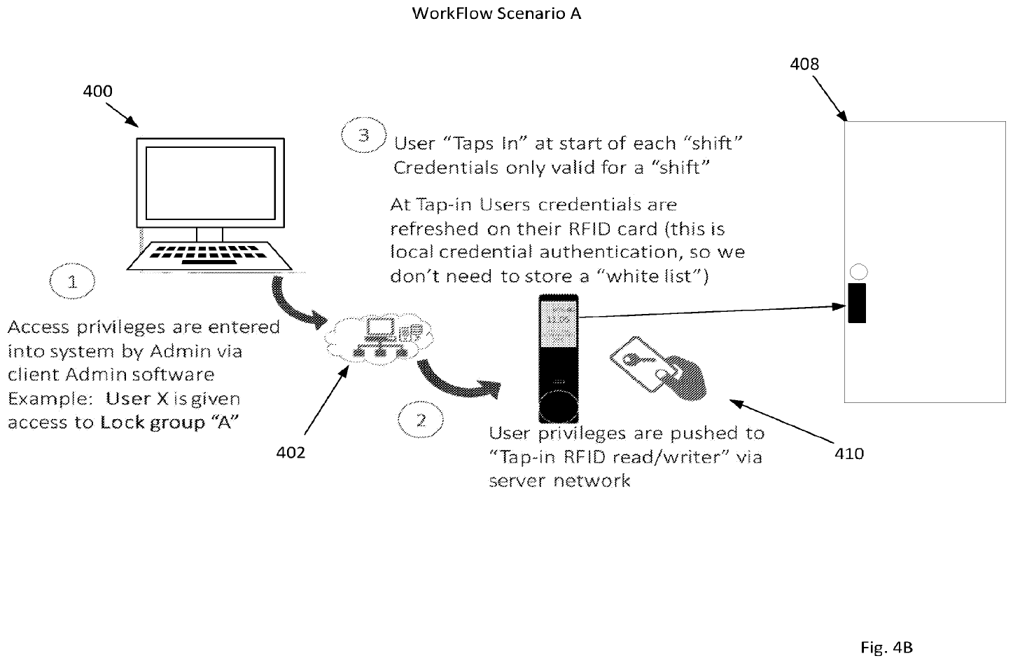

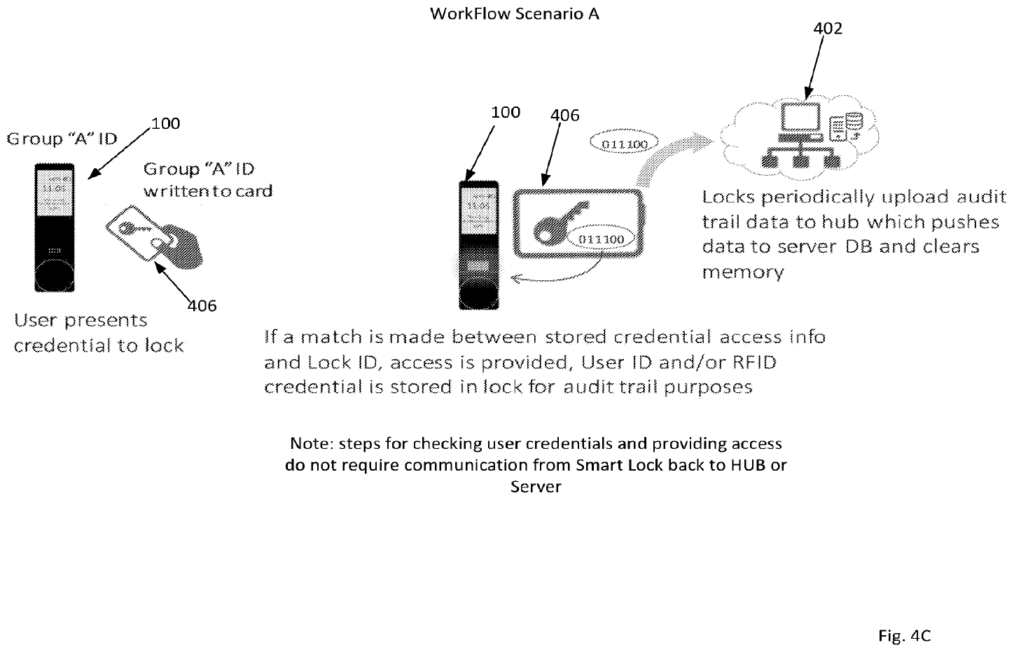

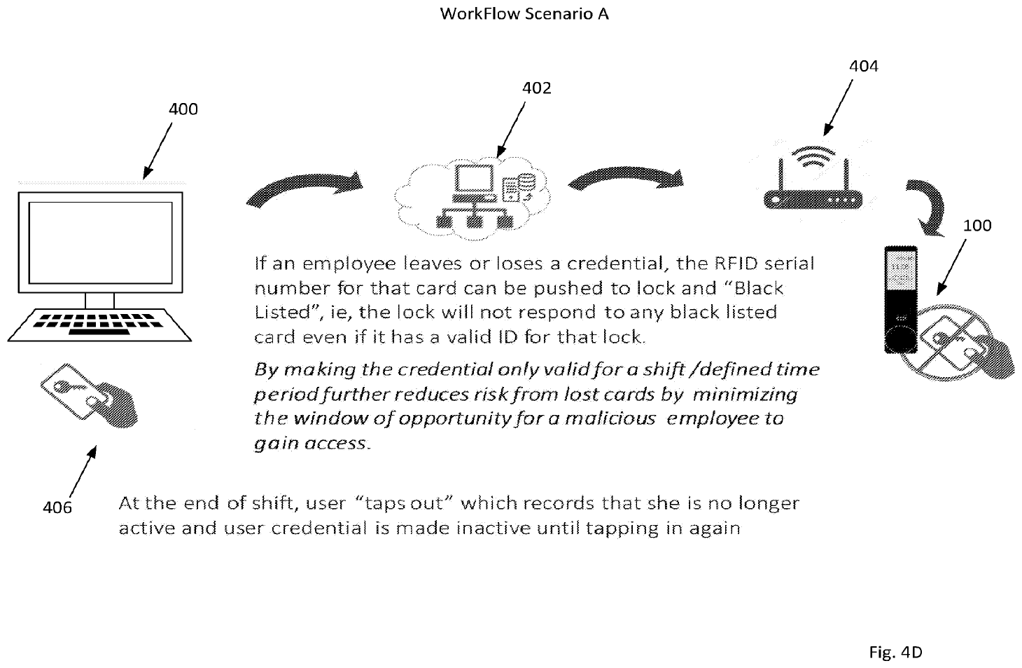

FIG. 4A shows that credentials are assigned to users by the administrator and pushed to one or more wireless latches 100. Specifically, in a first step, the administrator uses an RFID reader (not shown) connected the administrator PC 400 to program the RFID cards (e.g. 406) with credentials assigned to corresponding users. In a second step, the administrator also uses PC 400 to assign the one or more wireless latches 100 IDs. These IDs may be unique to each wireless latch 100, or may be shared as a group ID amongst multiple wireless latches 100. In a third step, the administrator pushes the IDs and credentials to the one or more wireless latches 100 via server 402 and communication HUB 404.

FIG. 4B shows an example of how the user privileges are assigned. For example, in a first step, the administrator enters user access privileges for the users for the one or more wireless latches 100 via PC 400. These privileges may include, for example, shift days/hours of when the specific users are able to unlock the one or more wireless latches 100. In a second step, the user access privileges are pushed to the one or more wireless latches 100 via the backend server 402 and the communication HUB 404. In a third step, when the user 408 taps-in their RFID card at the RFID reader 410 (e.g. connected to or integral to the one or more wireless latches 100), the RFID credential is received by the one or more wireless latches 100 which then compares the RFID credential to the user access privileges pushed from PC 400. If the user has valid privileges, the one or more wireless latches 100 are opened. The RFID reader of the one or more wireless latches 100 may also be used to refresh (e.g. reprogram) the credentials on the RFID card. This refreshing functionality at the latch is useful so that the administrator can update the user's credentials remotely anytime the user taps-in at a latch.

FIG. 4C shows that an audit trail of successful and unsuccessful attempts to open or access or interact with the one or more wireless latches 100 may also be generated. In the first step, the user taps-in to the one or more wireless latches 100 with the RFID card 406. In a second step, if a match is made between the stored user credential associated with the RFID card, the latch is opened (e.g. pawl is retracted) and the credential is stored in the latch as an audit trail that shows the time that the one or more wireless latches 100 were accessed by the user. In a third step, the audit trail is uploaded (e.g. periodically, in response to a request by the administrator, etc.) to the backend server 402 to avoid large audit trail files being stored in latch memory. This also allows the administrator to download the audit trails for review.

FIG. 4D shows that user credentials can be updated if needed (e.g. when an employee leaves or loses a credential). In a first step, the RFID serial number for the RFID card that is no longer valid may be pushed to the one or more wireless latches 100 via the backend server 402 and communication HUB 404, where it is then stored in what is known as a black list (e.g. list of unauthorized RFID cards). If the black listed RFID card is used in the future, the latch will check the black list and prevent access to the secure area. The black list may be time based to implement time restrictions that ensure that users are only allowed access to the secure container during a certain time period (e.g. during their work shift). These otherwise valid users are simply added to the black list during times outside of their work shift hours, and then removed from the black list during their work shift hours.

### Workflow Example B (White List RFID)

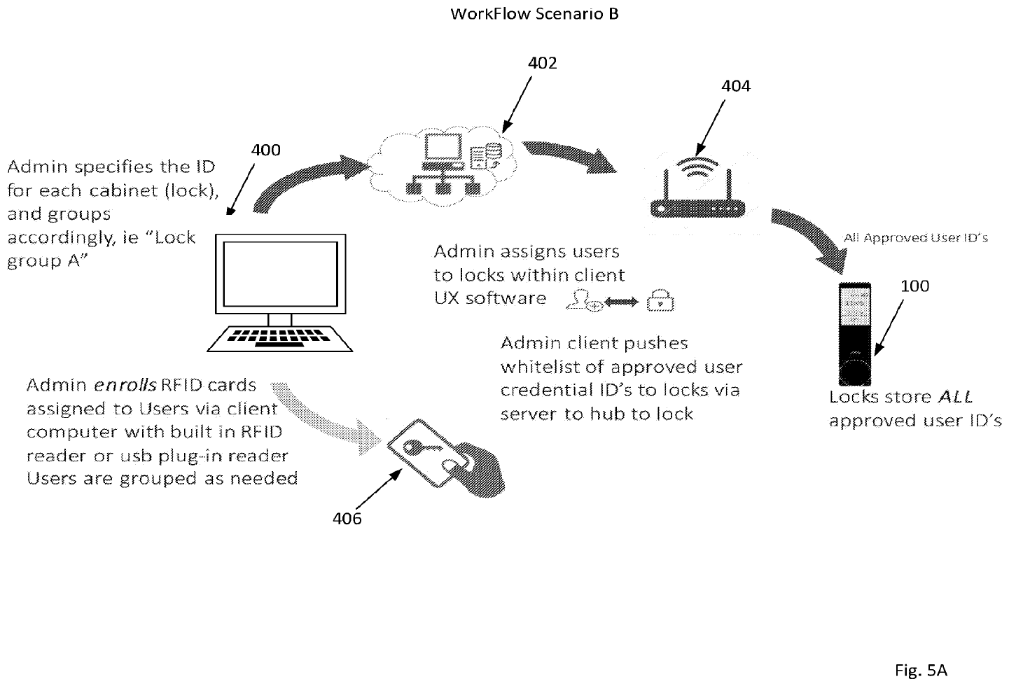

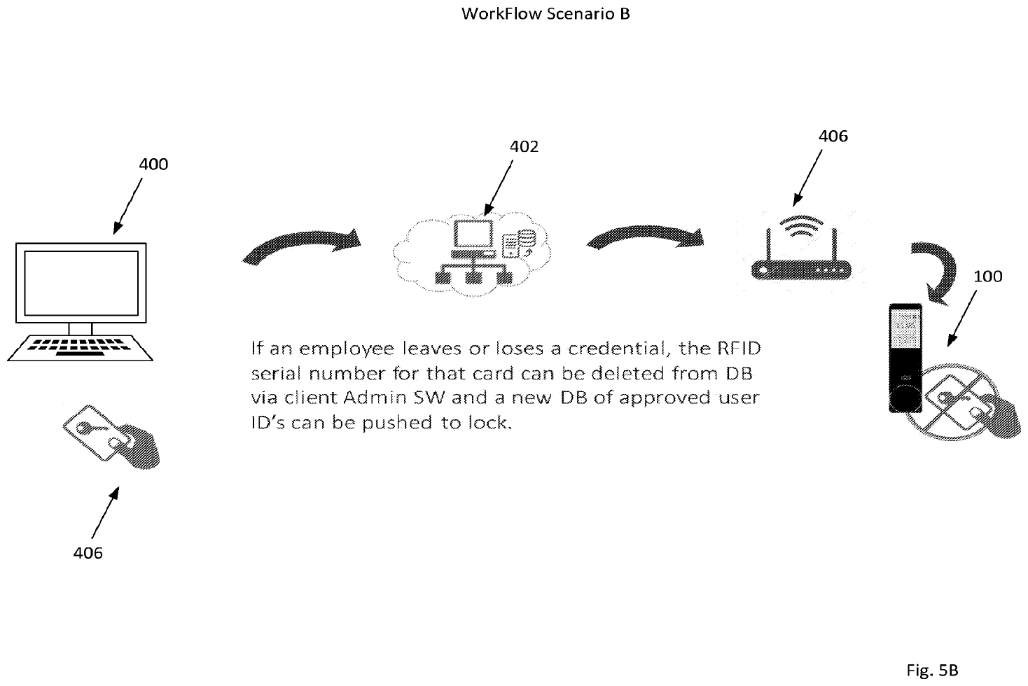

FIG. 5A is somewhat similar to the process shown in FIG. 4A, in that FIG. 5A shows that credentials are assigned to users by the administrator and pushed to one or more wireless latches 100. Specifically, in a first step, the administrator uses an RFID reader (not shown) connected the administrator PC 400 to program the RFID cards 406 with credentials assigned to corresponding users. In a second step, the administrator also uses PC 400 to assign the one or more wireless latches 100 IDs. These IDs may be unique to each wireless latch 100, or may be shared as a group ID amongst multiple wireless latches 100. In a third step, the administrator pushes the IDs and credentials in what is referred to as a white list (list of authorized users) to the one or more wireless latches 100 via server 402 and communication HUB 404.

Although not shown, user privileges are assigned in a manner similar to that shown in FIG. 4B, and an audit trail of successful and unsuccessful attempts to open the one or more wireless latches 100 may also be generated in a manner similar to that shown in FIG. 4C.

FIG. 5B shows that user credentials can be updated if needed (e.g. when an employee leaves or loses a credential). In a first step, the RFID serial number for the RFID card that is no longer valid may be removed from the white list which is then pushed to the one or more wireless latches 100 via the backend server 402 and communication HUB 404, where it is then stored as an updated white list (e.g. updated list of authorized RFID cards that excludes the removed RFID serial number). If the removed RFID card is used in the future, the latch will check the white list and prevent access to the secure area. The white list may be time based to implement time restrictions that ensure that users are only allowed access to the secure container during a certain time period (e.g. during their work shift). These otherwise valid users are simply removed from the white list during times outside of their work shift hours, and then added to the white list during their work shift hours.

FIG. 5C shows a modified scenario of the workflow described in FIGS. 5A and 5B. Specifically, in FIG. 5C, the administrator PC 400 pushes the white list (list of authorized users) to the HUB 404 (not the latch) via server 402. In this scenario, the one or more wireless latches 100 would respond to RFID tap-in by either requesting the white list from the HUB or sending the RFID serial number to the HUB for verification. In the later example, the HUB would compare the RFID tap-in serial number to the white list and send unlock instructions to the one or more wireless latches 100.

### Workflow Example C (Smart Device)

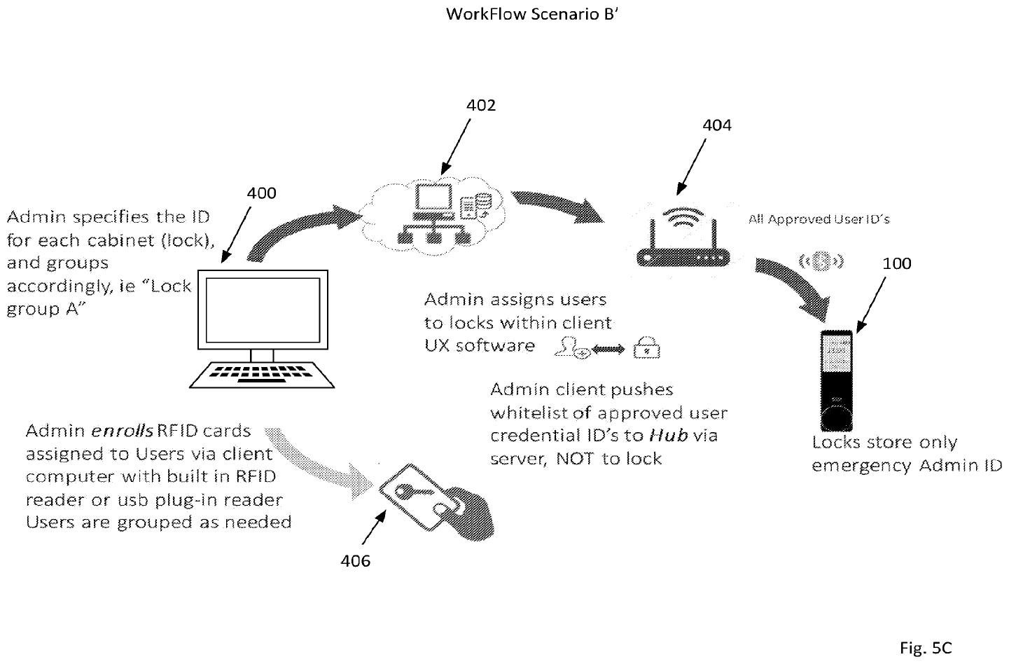

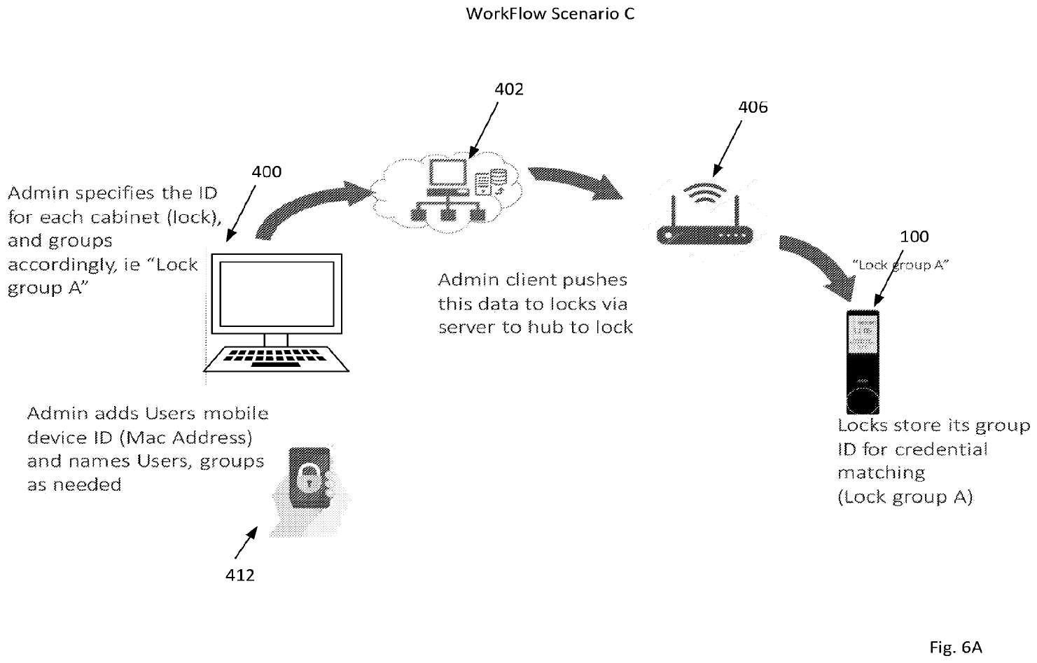

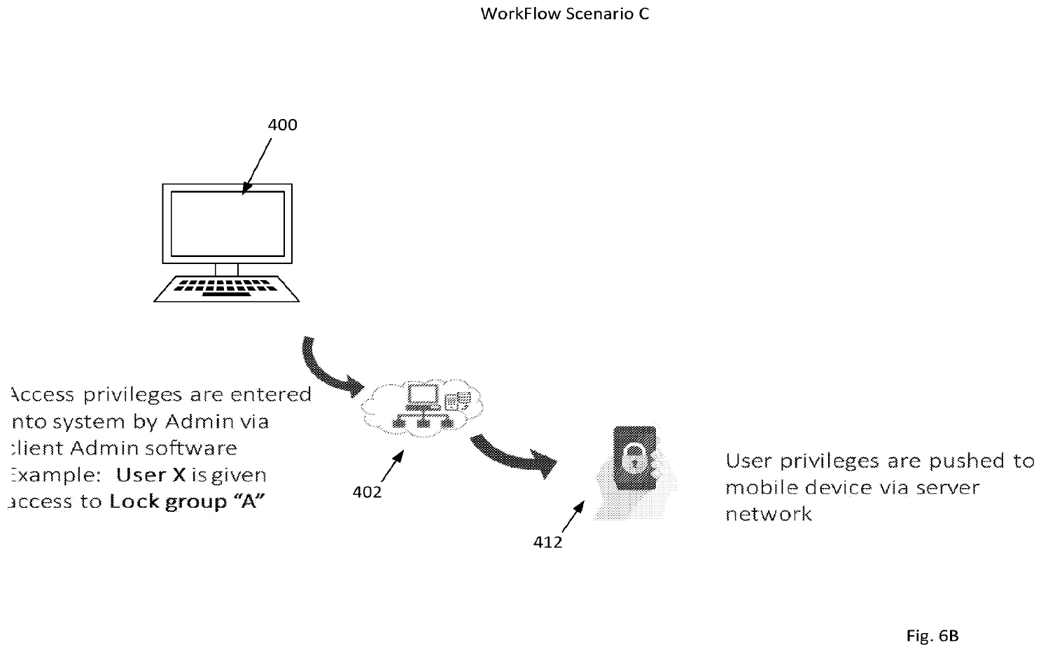

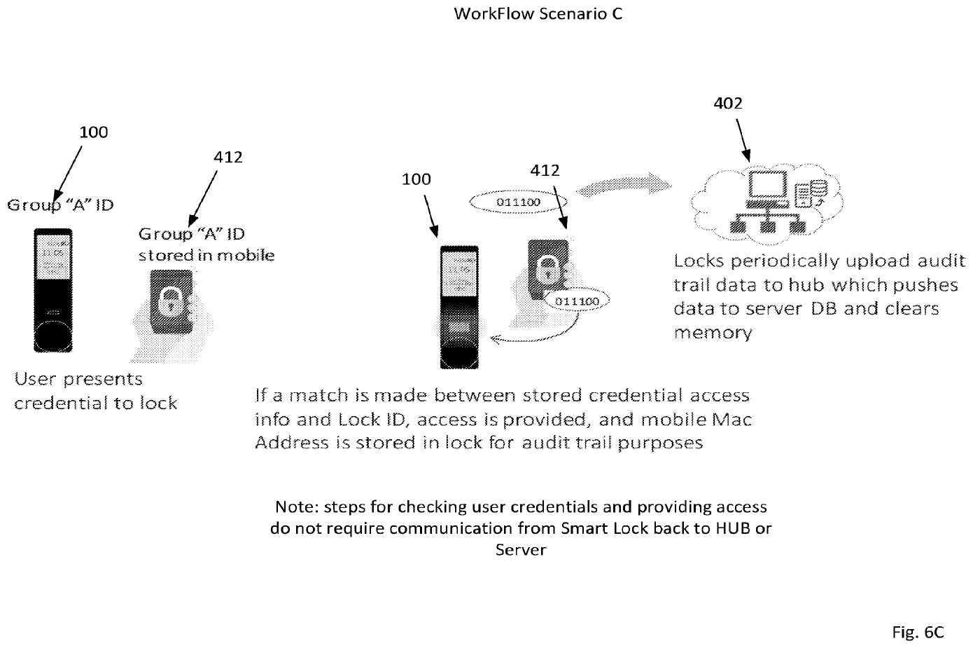

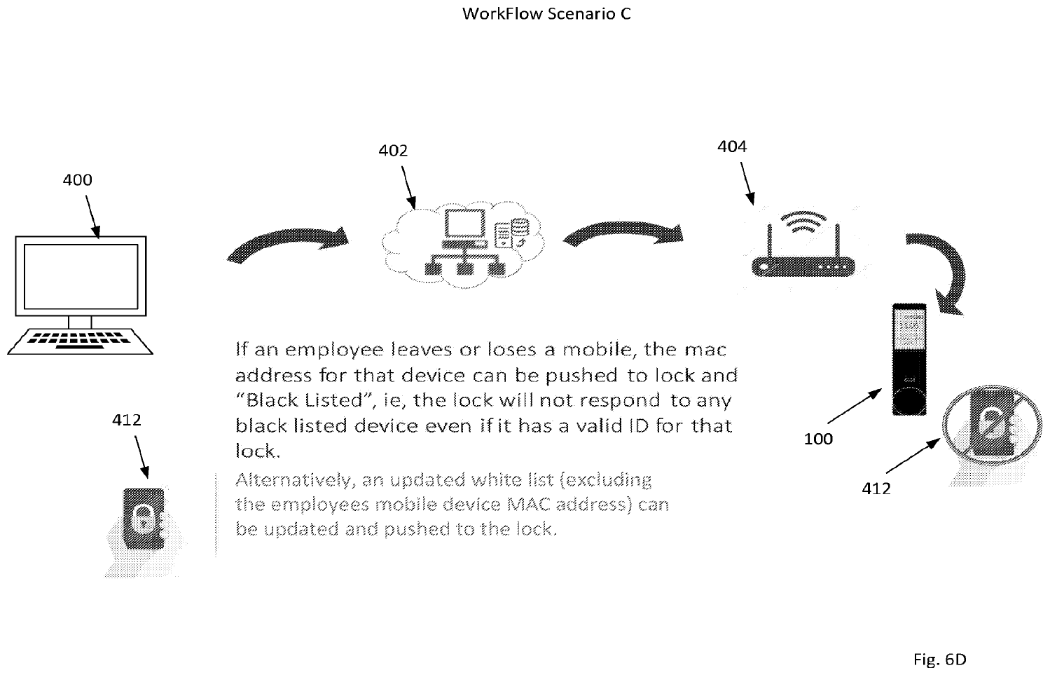

FIG. 6A shows that credentials are assigned to users by the administrator and pushed to one or more wireless latches 100. Specifically, in a first step, the administrator PC 400 to receive identity information (e.g. MAC address) of a user's mobile device (e.g. smart phone). In a second step, the administrator also uses PC 400 to assign IDs to the one or more wireless latches 100. These IDs may be unique to each wireless latch 100, or may be shared as a group amongst multiple wireless latches 100. In a third step, the administrator pushes the IDs and credentials to the one or more wireless latches 100 via server 402 and communication HUB 404.

FIG. 6B shows an example of how the user privileges are assigned. For example, in a first step, the administrator enters user access privileges for the users for the one or more wireless latches 100 via PC 400. These privileges may include for example, shift days/hours of when the specific users or groups of users are able to unlock the one or more wireless latches 100. In a second step, the user access privileges are pushed to the mobile device 412.

FIG. 6C shows that an audit trail of successful and unsuccessful attempts to open the one or more wireless latches 100 may also be generated. In the first step, the user positions mobile device 412 in proximity to the one or more wireless latches 100 at which point mobile device 412 wirelessly transmits (e.g. via Bluetooth®, Near Field Communications, etc.), the user credential (e.g. MAC address) to the one or more wireless latches 100. In a second step, if a match is made between the stored user credential associated with mobile device 412, the latch is opened (e.g. pawl is retracted) and the credential is stored in the latch as an audit trail that shows the time that the one or more wireless latches 100 were accessed by the user. In a third step, the audit trail is uploaded (e.g. periodically, in response to a request by the administrator, etc.) to the backend server 402 to avoid large audit trail files being stored in latch memory. This also allows the administrator to download the audit trails for review.

FIG. 6D shows that user credentials can be updated if needed (e.g. when an employee leaves or loses a credential). In one example, the MAC address for mobile device 412 that is no longer valid may be pushed to the one or more wireless latches 100 via the backend server 402 and communication HUB 404, where it is then stored in a black list. Alternatively, the MAC address for mobile device 412 that is no longer valid may be removed from the white list which is then pushed to the one or more wireless latches 100 via the backend server 402 and communication HUB 404.

### Workflow Example D (External Credential Source)

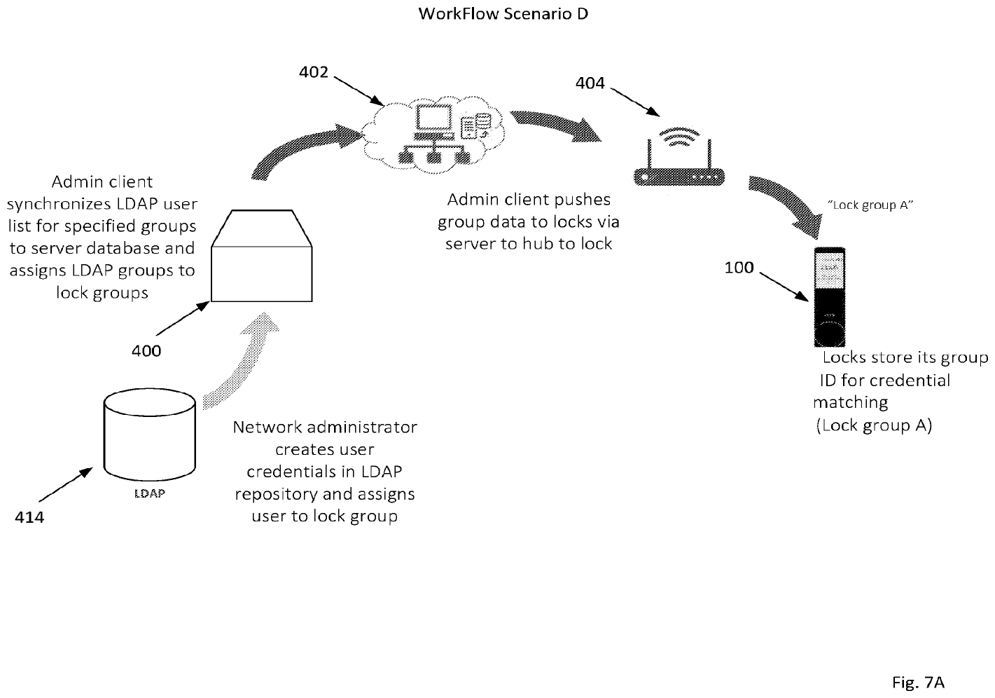

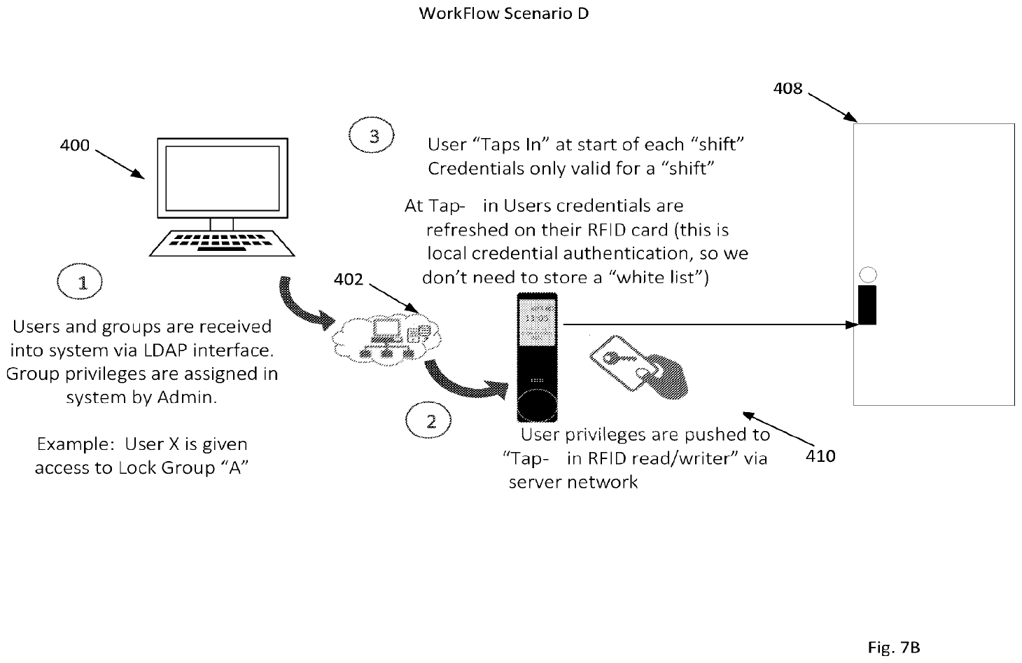

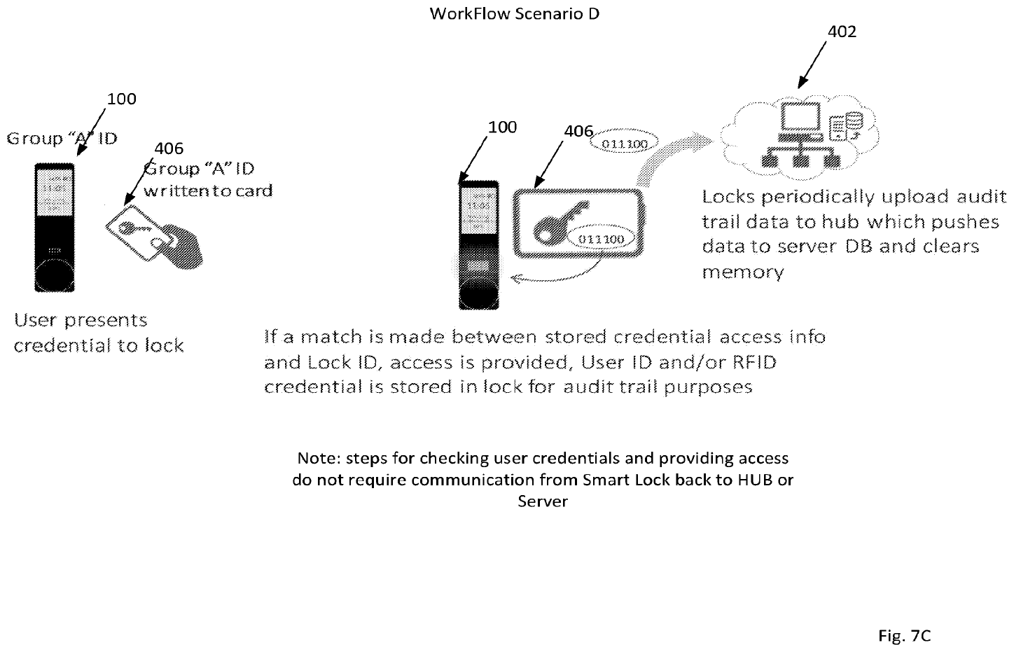

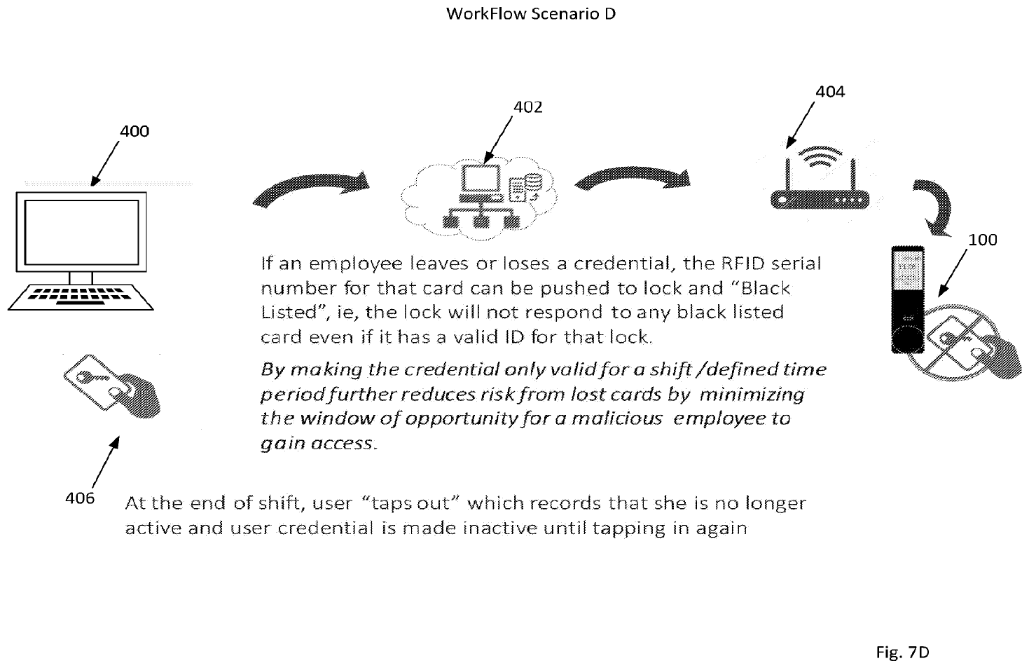

FIG. 7A shows that credentials are created by an external source (e.g. 3^{rd} party) and assigned to a group of users by the administrator and pushed to one or more wireless latches 100. Specifically, in a first step, a network administrator 414 creates user credentials in repositories (e.g. lightweight directory access protocol (LDAP) repositories) and assigns users to a group (e.g. group ID) of one or more wireless latches 100 (e.g. group of latches). In a second step, the administrator synchronizes the LDAP user list and assigns LDAP groups (e.g. group ID) to the one or more wireless latches 100 (e.g. latch groups). In a third step, the administrator pushes the group IDs and credentials to the one or more wireless latches 100 via server 402 and communication HUB 404.

FIG. 7B shows an example of how the user privileges are assigned. For example, in a first step, the administrator receives the group IDs via the LDAP interface and then enters access privileges for the groups with respect to the one or more wireless latches 100 via PC 400. In a second step, the group access privileges are pushed to the one or more wireless latches 100 via the backend server 402 and the communication HUB 404. In step three, when the user 408 taps-in their RFID card at the RFID reader 410 (e.g. connected to or integral to the one or more wireless latches 100), the RFID credential (e.g. group ID) is received by the one or more wireless latches 100 which then compares the RFID credential to the group access privileges pushed from PC 400. If the user of the group has valid privileges (e.g. group ID), the one or more wireless latches 100 are opened. The RFID reader of the one or more wireless latches 100 may also be used to refresh (e.g. reprogram) the credentials on the RFID card. This refreshing functionality can avoid the need to store a local white list at the latch.

FIG. 7C shows that an audit trail of successful and unsuccessful attempts to open the one or more wireless latches 100 may also be generated. In the first step, the user taps-in to the one or more wireless latches 100 with the RFID card 406. In a second step, if a match is made between the stored credential associated with the RFID card (e.g. group ID), the latch is opened (e.g. pawl is retracted) and the credential is stored in the latch as an audit trail that shows the time that the one or more wireless latches 100 were accessed by the user. In a third step, the audit trail is uploaded to the backend server 402.

FIG. 7D shows that user credentials can be updated if needed (e.g. when an employee leaves or loses a credential). In a first step, the RFID serial number for the RFID card that is no longer valid may be pushed to the one or more wireless latches 100 via the backend server 402 and communication HUB 404, where it is then stored in a black list. If the black listed RFID card is used in the future, the latch will check the black list and prevent access to the secure area. As previously discussed, the black list may be time based to implement time restrictions that ensure that users are only allowed access to the secure container during a certain time period (e.g. during their work shift). Alternatively, the RFID serial number for the RFID card that is no longer valid may be removed from the white list (e.g. list of authorized user/group IDs) which is then pushed to the one or more wireless latches 100 via the backend server 402 and communication HUB 404.

### Non-Medical Applications

Although wireless latch device and system has been described for use in medical applications (e.g. medicine cabinets), the wireless latch can be used to secure any compartment or room or area or enclosure or space. For example, FIG. 8 shows some examples of non-medical applications for a wireless latch that include but are not limited to rail (e.g. access to board the train, access to enter the conductor compartment, etc.), lockers, self-storage containers, recreational vehicles (e.g. access to board the RV, access to rooms in the RV, etc.), industrial equipment (e.g. access to restricted areas in the facility, access to operating certain machines, etc.) and retail (e.g. access to the store, access to restricted areas in the store, access to restricted display cases, etc.). Accordingly, this invention can be applied to any application or mixed applications.

### Wireless Latch (Mechanical)

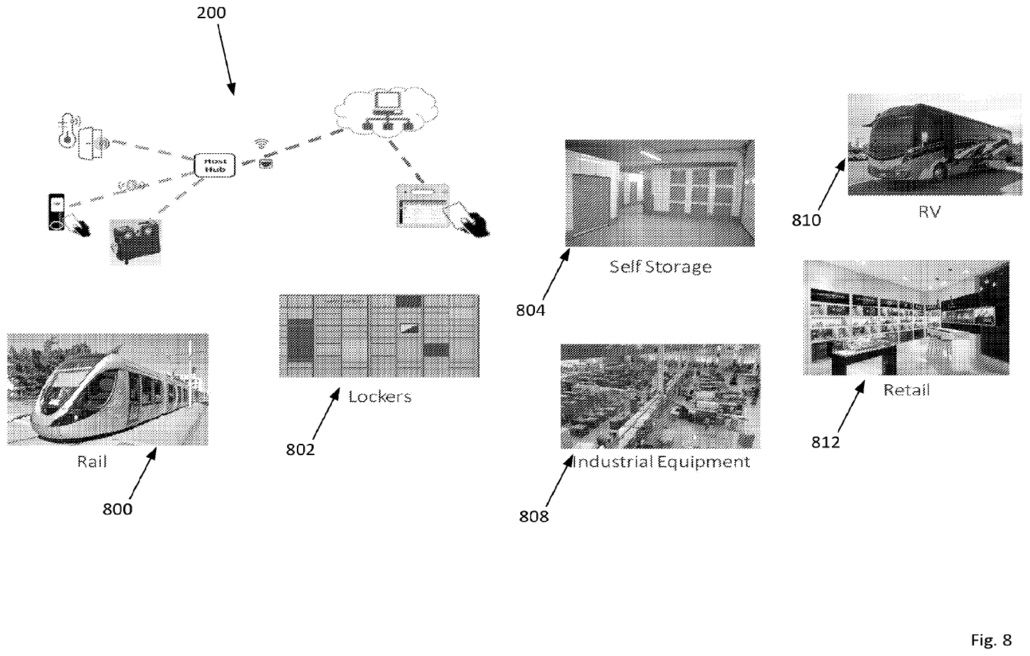

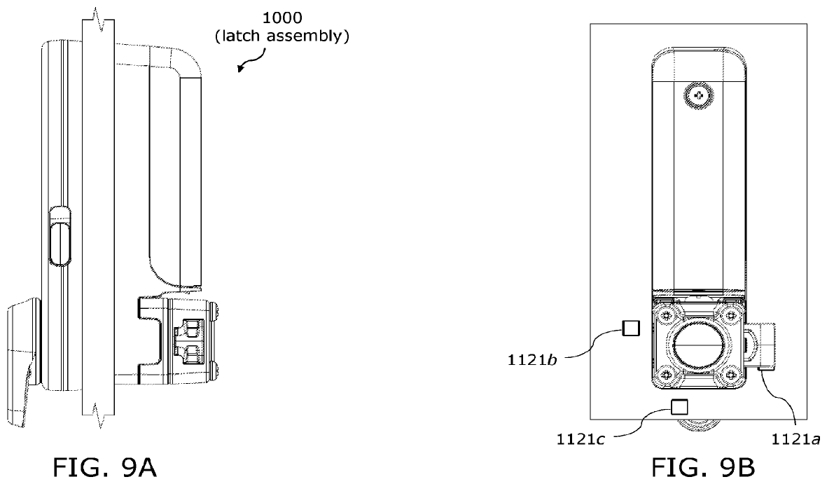

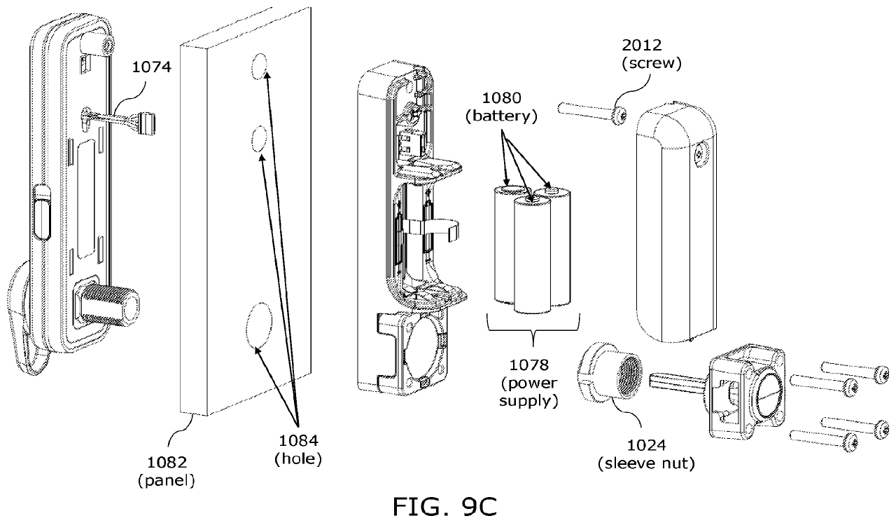

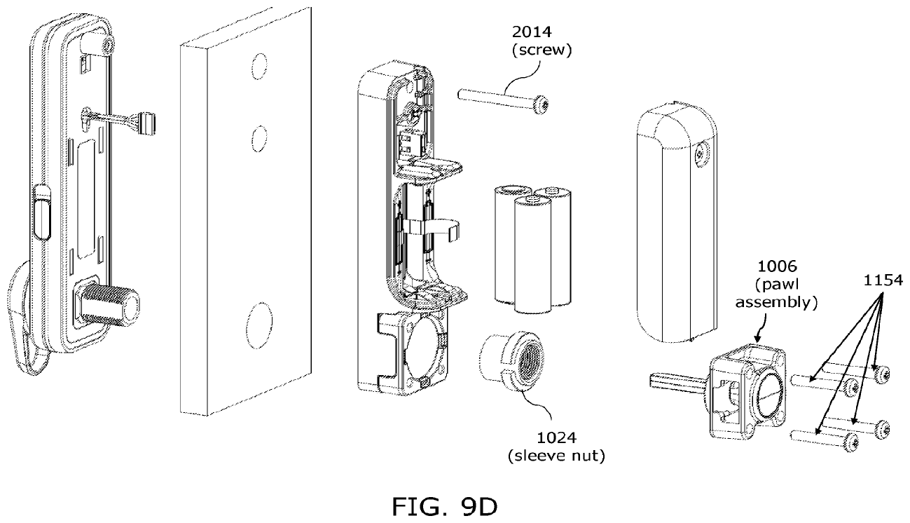

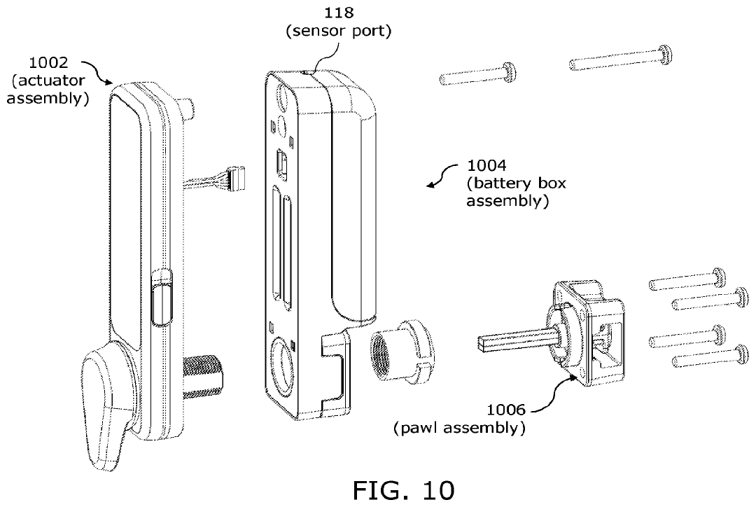

Turning now to a description of the wireless latch 100 and referring specifically to FIGS. 9A-9C and 10, a first embodiment of the wireless latch 100 is illustrated. A wireless latch 100, such as latch assembly 1000, is configured for mounting to an enclosure or compartment defining a secure space, as illustrated in the examples depicted in FIG. 8. In general, the latch assembly 1000 includes components, such as a housing 1002 configured to enclose one or more components of the latch assembly 1000, an actuator 1014 configured to be moveable for permitting access to the secure space, and a latch 1006 that is movable between unlatched and latched conditions. As seen in FIG. 10, the latch assembly 1000 includes the housing 1002, such as the actuator assembly 1002, a battery box assembly 1004, and the latch mechanism, such as pawl assembly 1006. Additional details of the latch assembly 1000 are described below.

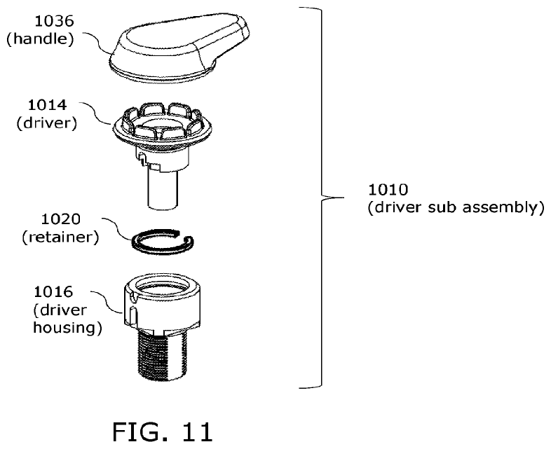

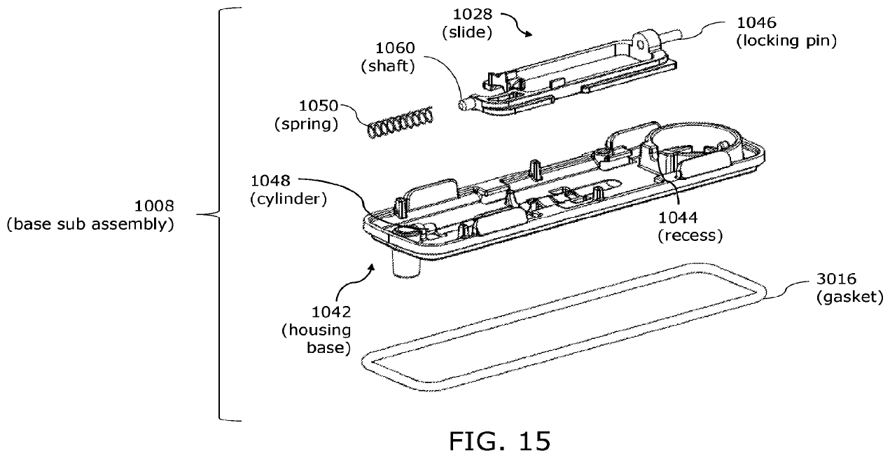

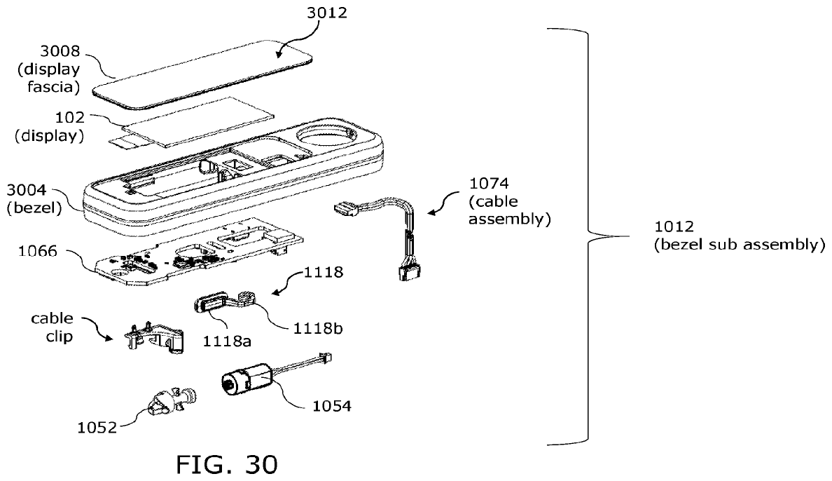

The housing, such as the actuator assembly 1002, is configured to enclose one or more components of the latch assembly 1000. In some examples, the housing 1002 incorporates or is connected to a number of separate components of the latch assembly 1000. As a non-limiting example, the housing 1002 may comprise a driver sub assembly 1010 (FIG. 11) coupled to a base sub assembly 1008 (FIG. 15) and a bezel sub assembly 1012 (FIG. 30).

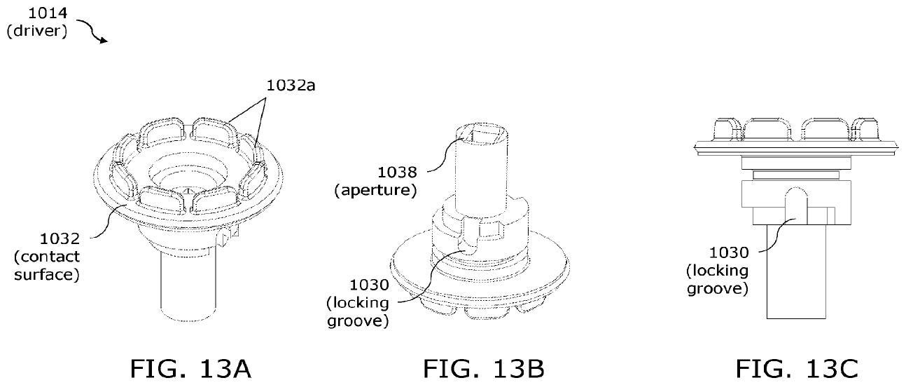

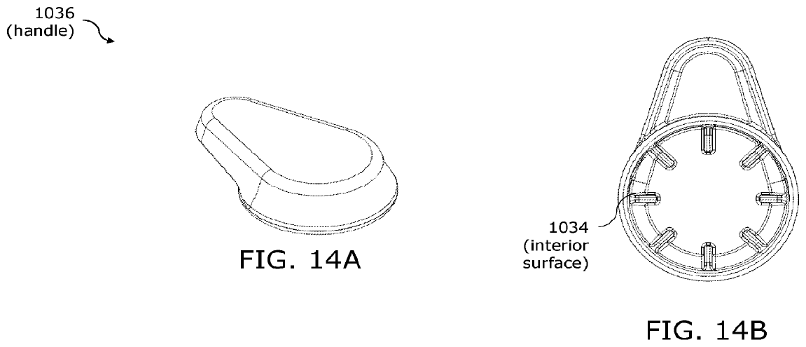

The driver sub assembly 1010, as illustrated in FIG. 11, includes an actuator, such as a driver 1014 (FIGS. 13A-13C), which is mounted for movement relative to the housing 1002. The driver sub assembly 1010 further includes a driver housing 1016 (FIGS. 14A-14C) defining an aperture 1018 configured to receive the driver 1014 via a fastening means, such as a retainer 1020. Other suitable attachment mechanisms will be known to one of ordinary skill in the art from the description herein.

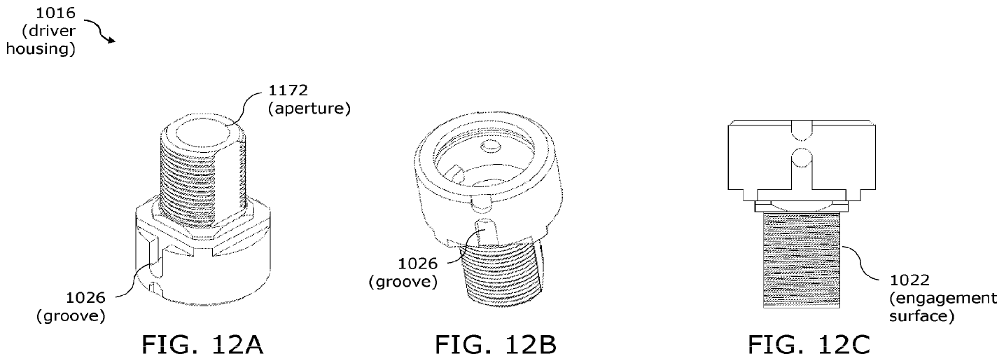

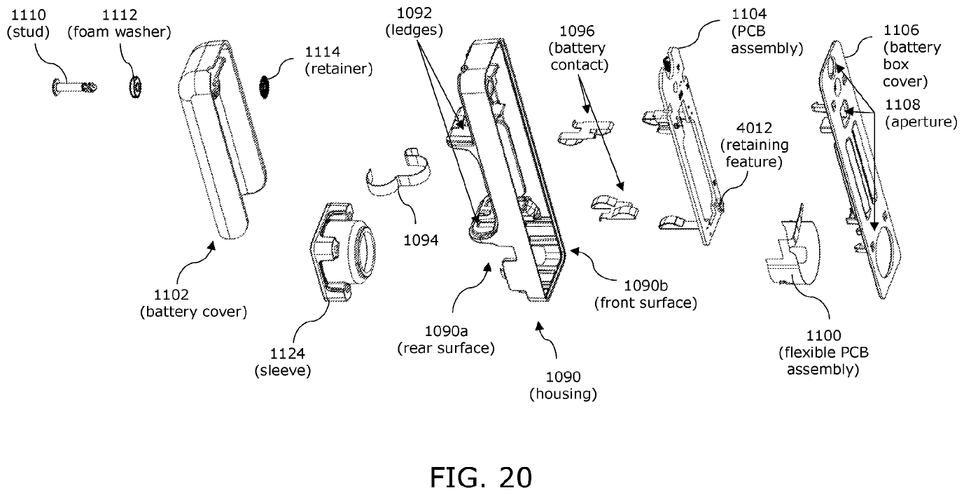

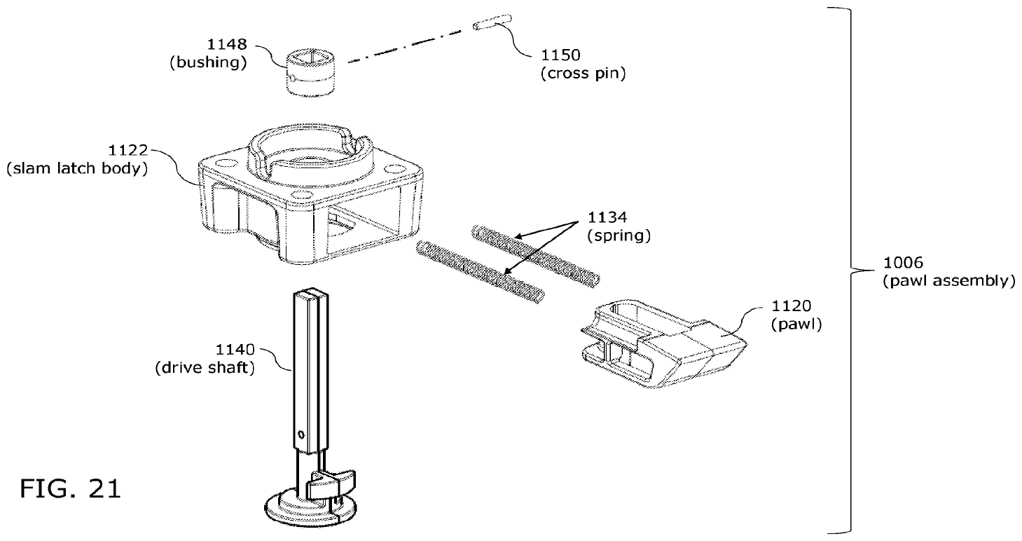

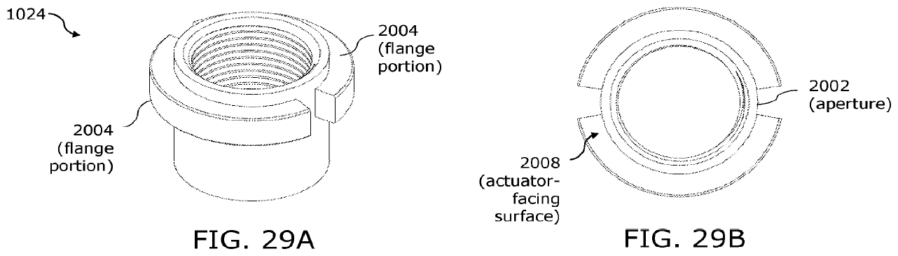

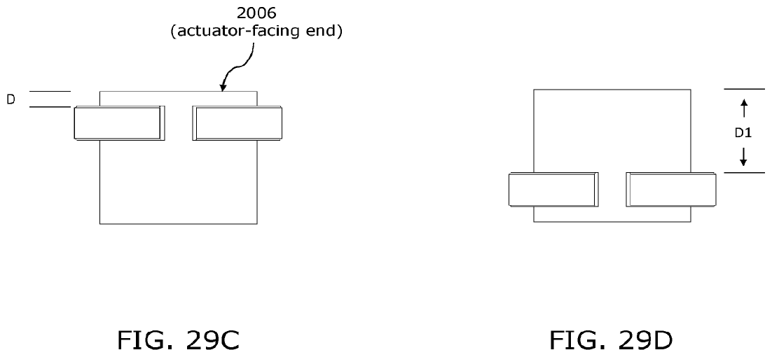

As best seen in FIGS. 12A-12C, the driver housing 1016 also defines a threaded surface 1022 configured for engagement with one or more components of the latch assembly 1000, such as the battery box assembly 1004 (FIG. 20), the pawl assembly 1006 (FIG. 21), and a sleeve nut 1024 (FIG. 29A-29D), all of which are discussed in further detail below. Additionally, the driver housing 1016 includes a contact surface, such as a groove 1026, which is configured to engage a slide 1028 (discussed in detail below). The groove 1026 of the driver housing 1016 has a size and shape that substantially corresponds to a locking groove 1030 of the driver 1014.

Turning now to the driver 1014, as illustrated in FIGS. 13A-13C, the driver 1014 includes a contact surface 1032, comprising a plurality of raised portions 1032a that correspond to an interior surface 1034 of a handle, such as knob 1036 (FIGS. 14A-14B). A person of ordinary skill in the art would understand from the description herein that the handle 1036 may be of any size or shape, which may additionally or optionally correspond with the size and shape of the actuator 1014. Additionally or optionally, the handle 1036 may have a size and shape that provides an ergonomic advantage for accessing the secure space of the enclosure.

Generally, the raised portions 1032a are positioned for coupling the handle 1036 to one or more components of the driver sub assembly 1010, such as the driver 1014. Specifically, the contact surface 1032 of the driver 1014 is configured to engage the interior surface 1034 of the handle 1036. In this way, the handle 1036 is in a fixed position relative to the driver 1014, such that the driver 1014 moves relative to the housing 1002 when the handle 1036 is moved, e.g. rotated in a clockwise or counterclockwise direction. For the driver 1014 to withstand frequent cycles of movement, e.g. rotation, it is desirable for the driver 1014 to be made of materials, such as metal or reinforced plastic, that can repeatedly and reliably used throughout many use cycles of latching and unlatching the latch assembly 1000.

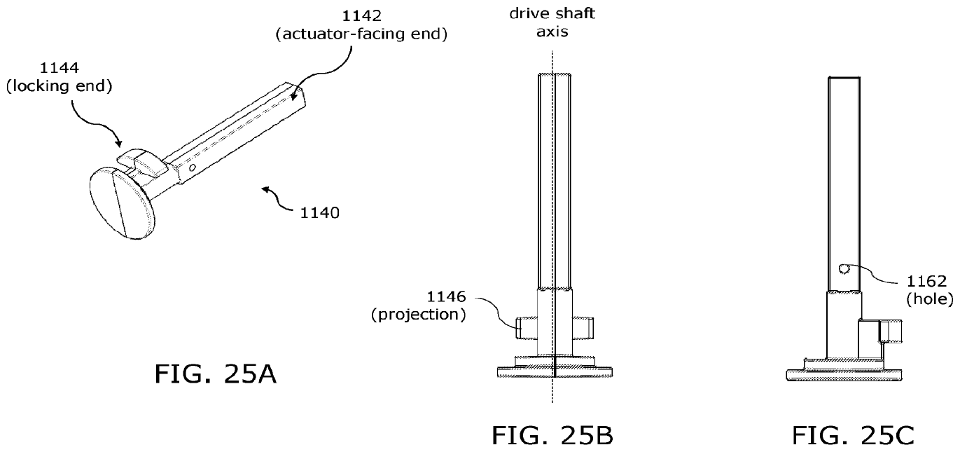

Additionally, in a non-limiting example, the driver 1014 further defines an aperture 1038 having a size and shape that corresponds to a size and shape of a drive shaft 1040 (FIG. 25A-25C), which is discussed in further detail below. Preferably, the size and shape of the aperture 1038 corresponds to the size and shape of the drive shaft 1040, such that the drive shaft 1040 is discouraged or limited from movement or rotation (e.g. anti-rotation effect) relative to the driver 1014 when the drive shaft 1040 at least partially extends through the aperture 1038 of the driver 1014. Although the driver 1014 is depicted (e.g. FIGS. 13A-13C) as defining the aperture 1038 to receive the drive shaft 1040, it should be understood that the pawl assembly 1006 may alternatively define the corresponding aperture 1038 to receive the driver 1014.

Moreover, as with the driver housing 1016, the driver 1014 defines a contact surface, such as the locking groove 1030, which is configured for engagement with the slide 1028. The locking groove 1030 further has a size and shape that substantially corresponds to the size and shape of the groove 1026 of the driver housing 1016.

Turning now to the base sub assembly 1008, as illustrated in FIG. 15, the base sub assembly 1008 includes the slide 1028 that is movable, e.g. slidable, relative to the housing 1002, between a retracted position and an extended position. Specifically, the housing, such as actuator assembly 1002, may comprise the base sub assembly 1008 that includes a housing base 1042 and the slide 1028 that is movable relative to the housing base 1042 between the retracted and extended positions. In particular, the housing base 1042 defines a U-shaped recess 1044 configured to at least partially receive or secure the slide 1028, such as the slide 1028 having a locking pin 1046 (discussed further below). The housing base 1042 also includes a hollow cylinder 1048 that is configured to contact or engage the biasing spring 1050 (discussed further below) as well as contact or engage a corresponding shaft 1060 defined by the slide 1028. In this way the U-shaped recess 1044 and the cylinder 1048 facilitates the movement of the slide 1028 relative to the housing base 1042 of the base sub assembly 1008, and ultimately relative to the housing or actuator assembly 1002.

In operation, a portion of the biasing spring 1050 may wrap around a portion of cylinder 1048 and a portion of shaft 1060. The hollow cylinder 1048 may be positioned to receive at least a portion of shaft 1060 when the slide 1028 is moved between the extended and retracted positions. Although hollow cylinder 1048 and housing base 1042 are integrally formed as a single body of unitary construction, a person of ordinary skill in the art would understand form the description herein that the hollow cylinder 1048 may optionally be a separate component that is distinct from the housing base 1042.

Furthermore, the size and shape of the hollow cylinder 1048 corresponds to the size and shape of the shaft 1060. In one non-limiting example, the shaft 1060 is positioned at one end portion of the slide 1028 and the shaft 1060 and the slide 1028 are integrally formed as a single body of unitary construction. A person of ordinary skill in the art would understand form the description herein that the shaft 1060 may optionally be a separate component that is distinct from the slide 1028.

As stated previously, the slide 1028 is movable between the retracted and extended positions by biasing means, such as biasing spring 1050. The biasing spring 1050 operates on the slide 1028 to bias the slide 1028 toward the extended position. Furthermore, the slide 1028 is configured for engagement with the actuator, such as the driver 1014, when the slide 1028 is in the extended position. Conversely, the slide 1028 is configured for disengagement from the actuator, such as the driver 1014, when the slide 1028 is in the retracted position.

To facilitate the engagement and disengagement of the slide 1028 from the actuator 1014, the latch assembly 1000 also includes the locking pin 1046 positioned for engagement by the locking groove 1030 of the actuator, such as the driver 1014, when the slide 1028 is in the extended position. Conversely, the locking pin 1046 is positioned for disengagement from the locking groove 1030 of the actuator, such as the driver 1014, when the slide 1028 is in the retracted position.

Specifically, when the locking pin 1046 is engaged by the locking groove 1030, the locking pin 1046 is in a fixed position relative to the actuator 1014, such that the locking pin 1046 and the actuator 1014 together prevent access to the secure space. Further, the locking pin 1046 may also be positioned for engagement with the corresponding groove 1026 of the driver housing 1016 when the slide 1028 is in the extended position and the locking pin 1046 may be positioned for disengagement from the groove 1026 of the driver housing 1016 when the slide 1028 is in the retracted position.

Still further, the size and shape of the locking pin 1046 corresponds to the size and shape of the locking groove 1030 of the driver 1014 and additionally or optionally, to the size and shape of the groove 1026 of the driver housing 1016. In one non-limiting example, the locking pin 1046 is positioned at one end portion of the slide 1028 and the locking pin 1046 and the slide 1028 are integrally formed as a single body of unitary construction. A person of ordinary skill in the art would understand form the description herein that the locking pin 1046 may optionally be a separate component that is distinct from the slide 1028.

Referring now to the bezel sub assembly 1012, as illustrated in FIG. 30, the bezel sub assembly 1012 comprises a drive cam 1052 and the electro-mechanical actuator 110, such as motor 1054. The drive cam 1052 is mounted for rotation relative to the housing 1002, such as the housing 1002 comprising the base sub assembly 1008 and the driver sub assembly 1010. The drive cam 1052 is also positioned adjacent the slide 1028, such that the drive cam 1052 is configured to move the slide 1028 against the operation of the biasing spring 1050 and toward the retracted position.

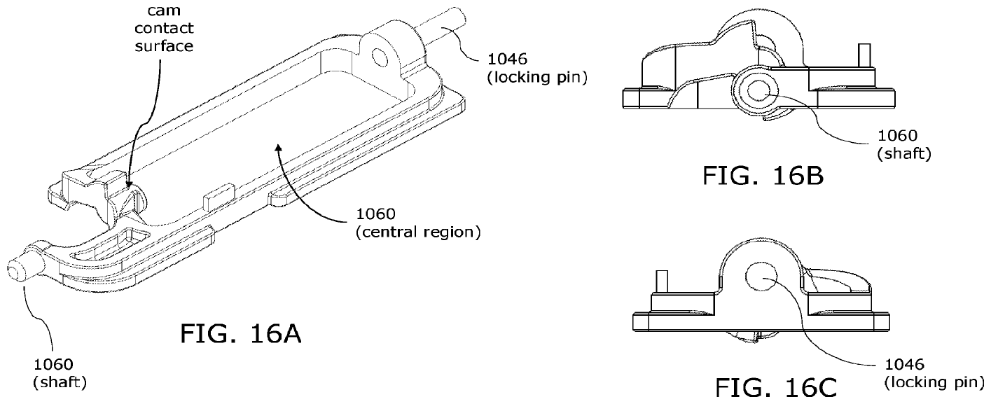

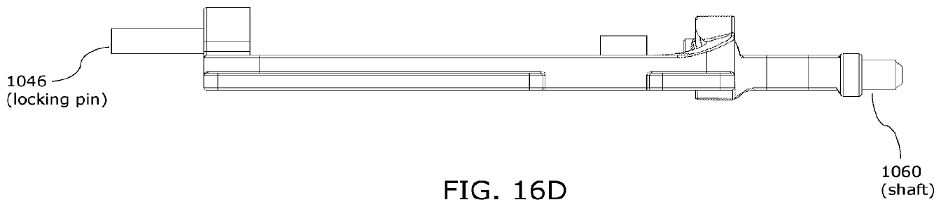

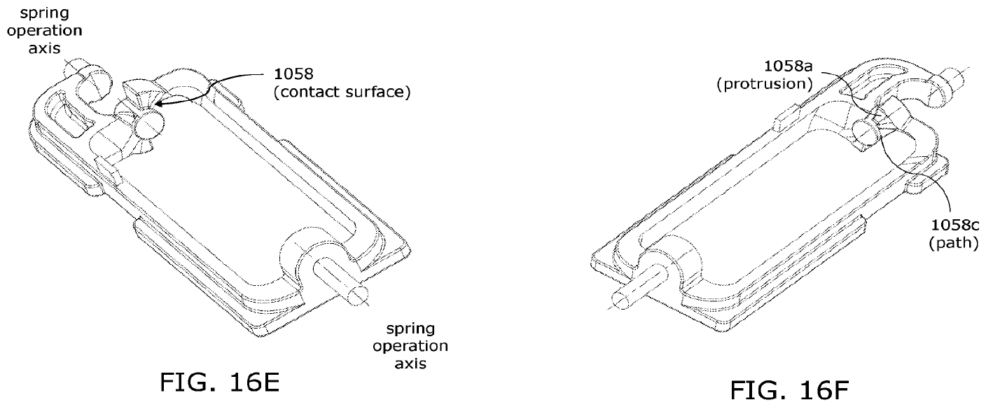

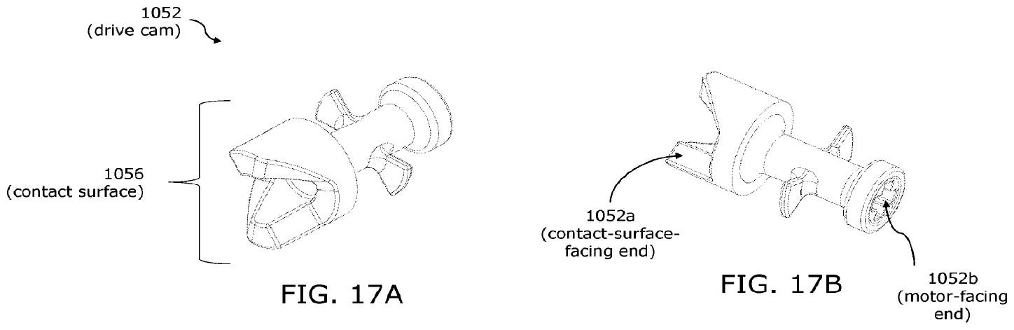

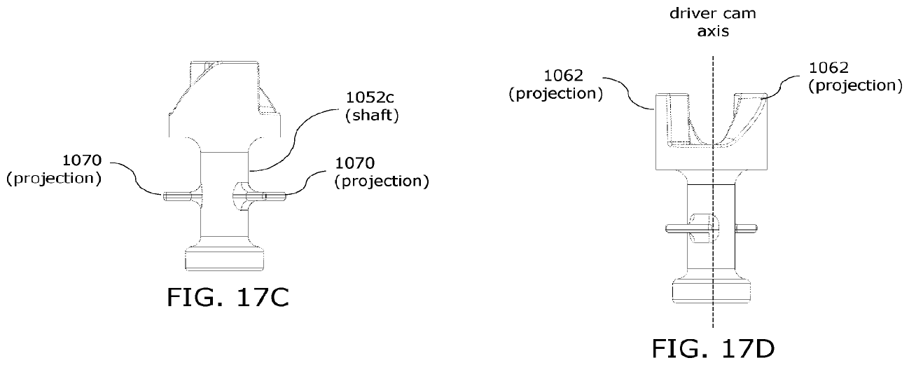

In one non-limiting example, the drive cam 1052 may be positioned in a central region 1060 defined by slide 1028 (FIG. 16A). To facilitate this movement, the drive cam 1052 defines a contact surface 1056 that substantially corresponds to a contact surface 1058 of the slide 1028. Specifically, the drive cam 1052 may include at least one tooth-like projection 1062 (FIG. 17D) configured to interface or engage with the contact surface 1058 of the slide. Additional details of the drive cam 1052 is discussed below.

In operation, the drive cam 1052 is configured for engagement by the motor 1054. Specifically, as seen in FIGS. 16A-16F and 17A-17D, the drive cam 1052 is configured to rotate about a drive cam axis (FIG. 17D) extending between a contact-surface-facing end 1052a and a motor-facing end 1052b of the drive cam 1052. In one non-limiting example, the drive cam axis is substantially parallel to the operation of the biasing spring 1050.

As the motor 1054 is activated and the drive cam 1052 rotates about the drive cam axis, the movement, e.g. rotation, of the drive cam 1052 is guided by the contact surface 1058 defined by the slide 1028. Generally, the contact surface 1058 guides movement of the drive cam 1052 when the motor is activated, such that the locking pin 1046 is positioned for disengagement from the locking groove 1030 of the actuator 1014 when the slide 1028 moves toward or is in the retracted position.

In one non-limiting example, as illustrated in FIGS. 16A-16F, the contact surface 1058 configured to guide movement of the drive cam 1052 is positioned in an opposite end portion of the slide 1028 relative to the locking pin 1046 and the contact surface 1058 and the slide 1028 are integrally formed as a single body of unitary construction. However, a person of ordinary skill in the art would appreciate from the description herein that the contact surface 1058 may optionally be a separate component distinct from the slide 1028.

More specifically, as seen in FIGS. 16E-16F, the contact surface 1058 of the slide 1028 comprises at least one protrusion 1058a extending radially outwardly from a cylindrical body 1058b that is coaxial with the drive cam axis, such that the at least one protrusion 1058a is configured to limit the rotation of the drive cam 1052 about the drive cam axis. In addition, the contact surface 1058 further defines a path 1058c along which at least one tooth-like projection 1062 of the drive cam 1052 moves in response to activation of the motor 1054.

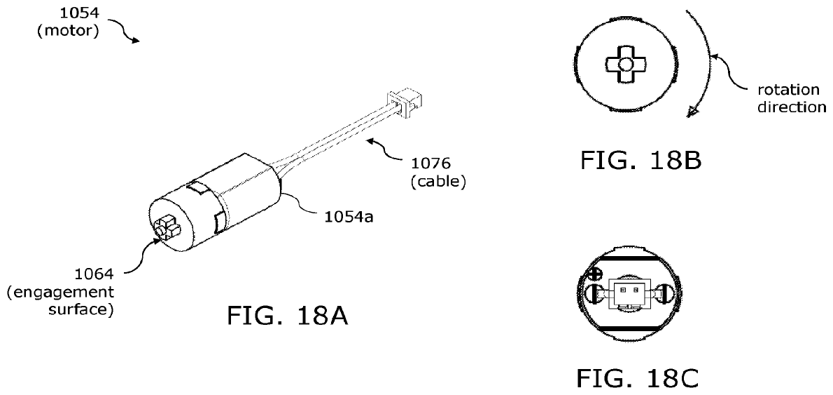

Turning now to the motor 1054, as illustrated in FIGS. 18A-18C, the motor-facing end 1052b of the drive cam 1052 is configured to engage an engagement surface 1064 of the motor 1054. The motor 1054 is configured to rotate, such as in a clockwise direction (as shown in FIG. 18B) or in a counter-clockwise direction. When the motor-facing end 1052b of the drive cam 1052 is engaged by the engagement surface 1064 of the motor 1054, the drive cam 1052 rotates in the same direction as the motor 1054. Preferably, the motor 1054 is a motor that is operable in efficient or low power conditions, such that it requires a relatively low voltage to operate. This low voltage allows the latch assembly 1000 to conserve power necessary for operation and is thus desirable for the latch assembly 1000 to reliably operate under conditions requiring high frequency use cycles.

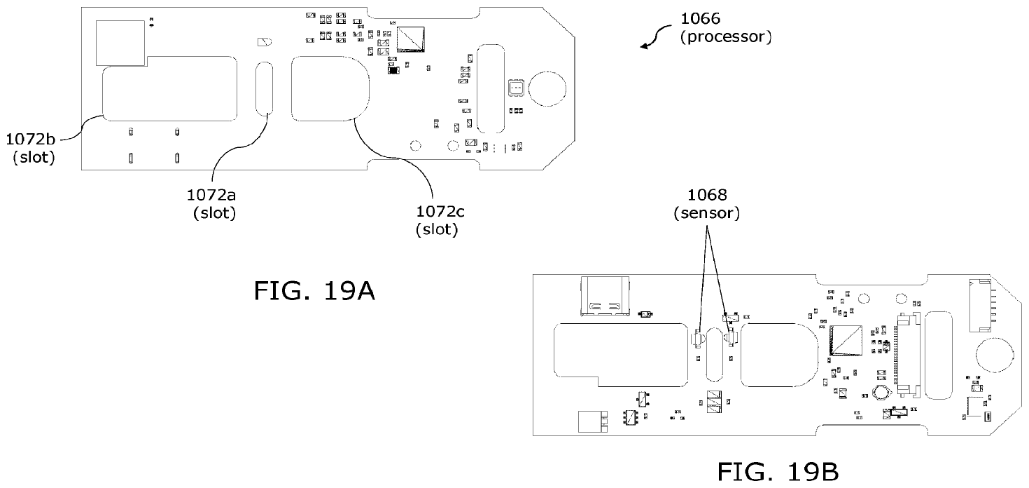

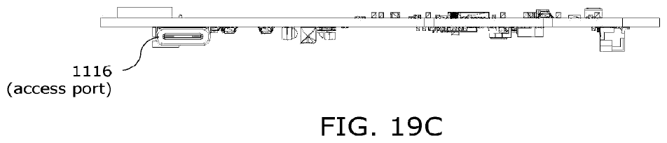

Referring now to FIGS. 19A-19C, the latch assembly further comprises the CPU 104, such as a processor or printed circuit board 1066, configured to perform a variety of functions relating to operation of the latch assembly 1000, including operation of the motor 1054 and at least one sensor 1068 of the latch assembly 1000.

In a non-limiting example, the at least one sensor 1068 is positioned to detect or sense the presence or position of the drive cam 1052. Specifically, the at least one sensor 1068 comprises at least one proximity sensor configured to detect or sense the drive cam 1052. More specifically, the at least one proximity sensor 1068 is configured to detect at least one projection 1070 of the drive cam 1052. As seen in FIGS. 17A-17D, the at least one projection 1070 extends radially outwardly from a cylindrical shaft 1052d of the drive cam 1052.

In operation, the at least one proximity sensor 1068 detects the at least one projection 1070 of the drive cam 1052 as the drive cam 1052 rotates about the drive cam axis when the motor 1054 is activated by the processor 1066. The detection of the at least one projection 1070 of the drive cam 1052 by the at least one proximity sensor 1068 is facilitated by a slot 1072 (FIG. 19A) mounted to a surface, such as the processor 1066. The slot 1072 is positioned adjacent to the at least one proximity sensor 1068 and the slot 1072 has a size and shape for accommodating the at least one projection 1070 of the drive cam 1052. Additionally or optionally, the processor may further define slots 1072b and 1072c for accommodating the size and shape of the motor 1054 and drive cam 1052, respectively.

The operation of the motor 1054 by the processor 1066 is facilitated by a cable 1076 (FIG. 18A) that couples the motor 1054 to the processor 1066. The processor 1066 is powered via a cable assembly 1074 (FIG. 30), which is connected to a power supply 1078 (FIG. 9C). In a non-limiting example, the power supply 1078 is an integrated power source with one or more batteries 112, e.g. batteries 1080 (FIG. 9C), such that the latch assembly 1000 is said to be self-contained. In a non-limiting example, the one or more batteries 1080 are stacked or arranged in a substantially triangular geometry. Advantageously, this substantially triangular geometry allows the latch assembly 1000 to satisfy specific size constraints of the enclosure or compartment defining the secured space or area.

Additionally or optionally, the power supply 1078 may be external to the latch assembly 1000. To facilitate this delivery of power, the housing 1002, such as the housing 1002 comprising the bezel sub assembly 1012, may define an access port 1116. The access port 1116 is further configured for engagement with a device (not shown) external to the latch assembly 1000.

In one non-limiting example, the external device may be a power source, such as external source 126. A connector, such as power port 124, coupled to the external power source 126 and received by the access port 1116 can thus facilitate the delivery of power to the latch assembly 1000 from the external device. Additionally or optionally, the one or more batteries 1080 may be charged from external power source 126 via the power circuit 116 which supplies conditioned voltage to the components of the latch assembly 1000.

Referring now to FIG. 20, the latch assembly 1000 may further comprise the battery box assembly 1004. The battery box assembly 1004 is positionable against a surface of the compartment or enclosure.

In a non-limiting example, as illustrated in FIGS. 9A-9D, the battery box assembly is configured to be positioned on an opposite side of a panel or door, such as panel 1082, relative to the actuator assembly 1002. Specifically, the battery box assembly 1004 is positioned on the opposite side of the panel 1082 relative to the actuator, such as the driver 1014.

As also illustrated by FIG. 9C, the panel 1082 may define one or more holes 1084, which may optionally be pre-determined by the type of enclosure or compartment, through which components of the latch assembly 1000 extend or to which components of the latch assembly are affixed. For example, one of the one or more holes 1084 may correspond to the size and shape of the actuator 1014 and another of the one or more holes 1084 may correspond to the size and shape of the cable assembly 1074. Additionally or optionally, one of the one or more holes 1084 may be configured to receive a fastening means, such as a screw 2012 (FIG. 9C) and a screw 2014 (FIG. 9D). Additionally or optionally, one of the one or more holes 1084 may be configured to receive the sleeve nut 1024.

The battery box assembly 1004 is configured to enclose one or more components of the latch assembly 1000. In a non-limiting example, as illustrated in FIGS. 9A-9D and 20, the battery box assembly 1004 comprises a housing 1090 defining a rear surface 1090a configured to secure the power supply 1078, such as the integrated power source having one or more batteries 1080. Suitable types (alkaline, lithium, rechargeable, etc.) and sizes (AA, AAA, etc.) of the one or more batteries 1080 will be known to one of ordinary skill in the art from the description herein. Specifically, the rear surface 1090a comprises raised portions forming one or more ledges 1092, such that the one or more ledges 1092 maintain the one or more batteries 1080 in a fixed position relative to the housing 1090.

Additionally or optionally, a battery pull ribbon 1094 is coupled to the rear surface 1090a for securing the one or more batteries 1080 within the battery box assembly 1004. Furthermore, the battery box assembly 1004 comprises a pair of battery contacts 1096 positioned to contact opposing surfaces of the one or more batteries 1080. The pair of battery contacts 1096 may help provide pressure to hold the one or more batteries 1080 in a fixed position relative to the housing 1090 as well as conduct an electrical current and deliver power from the one or more batteries 1080 to one or more desired circuits, such as the processor 1066, the printed circuit board assembly 1104, and the flexible circuit board assembly 1100 (discussed further below). Suitable materials for the battery contacts 1096 will be known to one of ordinary skill in the art from the description herein. Finally, the battery box assembly 1004 further includes a battery cover 1102 having a shape and size that corresponds to the housing 1090, such that together the housing 1090 and the battery cover 1102 enclose one or more components of the battery box assembly 1004, including the one or more batteries 1080.

The housing 1090 of the battery box assembly 1004 may further define an opposing surface 1090b relative to the rear surface 1090a. The opposing surface 1090b is configured to partially enclose the printed circuit board assembly 1104 and the flexible circuit board assembly 1100 (discussed in further detail below). The opposing surface 1090b is further configured to be coupled to a battery box cover 1106, which may define at least a plurality of apertures 1108 that substantially correspond with the one or more holes 1084 defined by the panel 1082 (FIGS. 9C-9D). The plurality of apertures 1108 are further configured to substantially correspond with one or more components of the actuator assembly 1002.

In one non-limiting example, as seen in FIGS. 9C-9D, the plurality of apertures 1108 may substantially correspond with the driver 1014 disposed within driver housing 1016 and the cable 1074. In addition, together with at least the housing 1090 and the battery cover 1102, one of the apertures 1108 may be configured to facilitate the attachment of the battery box assembly 1004 to the panel 1082. Attachment may be accomplished via suitable fastening means comprising at least a stud 1110, a foam washer 1112, and a retainer 1114. Other suitable fastening means will be known by a person of ordinary skill in the art from the description herein.

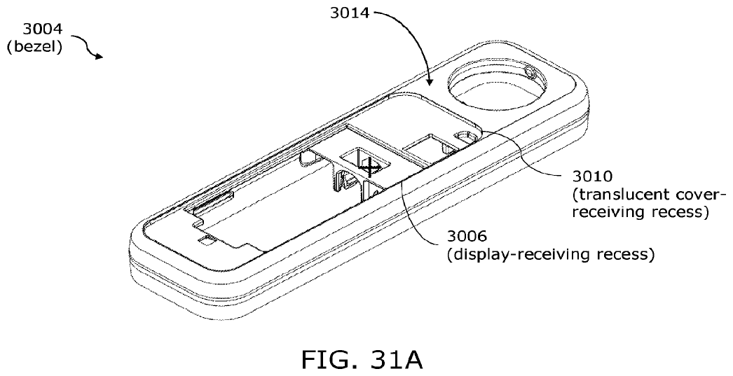

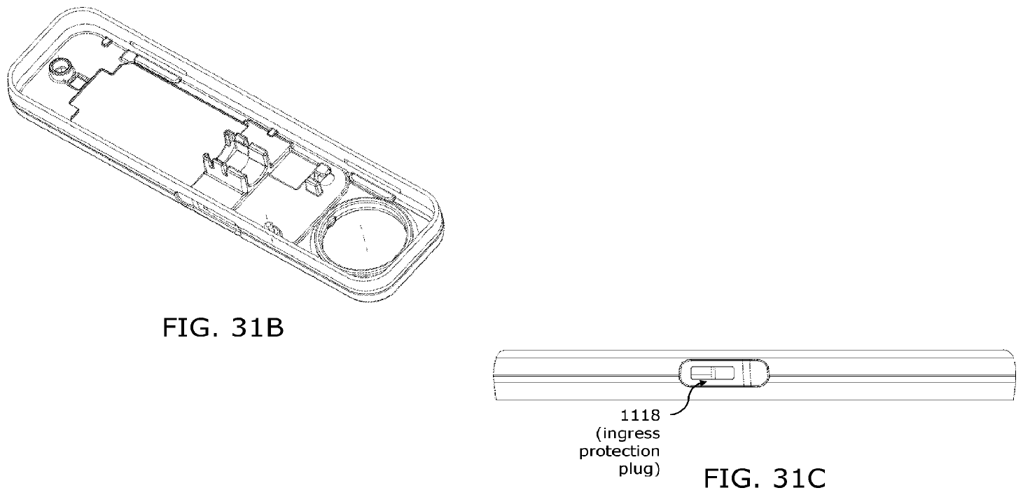

Furthermore, the housing, such as the housing 1002 comprising the bezel sub assembly 1012, may include an ingress protection plug 1118 (FIGS. 30 and 31C). The ingress protection plug 1118 comprises a tether 1118b, configured for attachment to the housing 1002, and a releasable cover 1118a, configured to be movable relative to the tether 1118b. Specifically, movement of the releasable cover 1118a can expose the access port 1116. Advantageously, the releasable cover 1118a may remain connected to the housing 1002 via the tether 1118b, for easy retrieval after se. The ingress protection plug 1118 may further provide an advantage to the invention, by restricting ingress of unwanted materials, e.g. dust, contaminants, moisture, etc. that may come in contact with the latch assembly 1000.

Turning now to FIG. 21, coupled to the actuator 1014 and configured to be movable between latched and unlatched conditions is the latch, such as the pawl assembly 1006. In general, the latch 1006 is moveable between the latched condition to prevent access to the secure space and the unlatched condition to permit access to the secure space. As seen in FIG. 21, the latch 1006 includes a pawl, such as ramp-ended pawl 1120, that is movable between locked and unlocked positions. In a non-limiting example, when the pawl 1120 is in the unlocked position, the latch 1006 is in the unlatched condition to permit access to the secure space and conversely, when the pawl 1120 is in the locked position, the latch 1006 is in the latched condition to prevent access to the secure space.

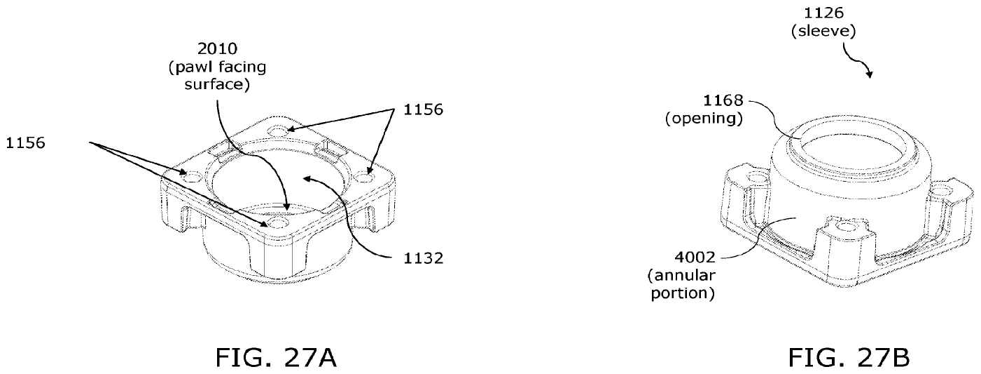

The latch 1006 includes a housing, such as a slam latch body 1122, that defines an annular portion 1124 that is configured to engage with a sleeve 1126 (FIG. 27A-27B) and the sleeve nut 1024, both of which are discussed in detail further below. Specifically, the annular portion 1124 defines an opening 1128 that substantially corresponds in shape and size with the sleeve nut 1126. Further, as seen in FIGS. 9C-9D, the exterior surface 1130 of the annular portion 1124 is configured to contact an interior surface 1132 (FIG. 27A) of the sleeve 1126. In addition, the housing 1122 defines a plurality of apertures 1152 that are configured to receive fastening means, such as one or more screws 1154 (FIG. 9D), for attaching the pawl assembly 1006 to the panel 1082. In one non-limiting example, as seen in FIGS. 9C-9D, the one or more screws 1154 are configured to attach the pawl assembly 1006 to the panel 1082 via the one or more screws 1154 being received by apertures 1152 of the housing 1122 and corresponding apertures 1156 (FIG. 27A) of the sleeve 1126.

The ramp-ended pawl 1120 is partially enclosed within the housing 1122 and is configured to be movable, e.g. slidable, relative to the housing 1122, between locked and unlocked positions. When the pawl 1120 is in the unlocked position, the pawl 1120 is in a retracted position and conversely, when the pawl is in the locked position, the pawl 1120 is in an extended position. Specifically, the pawl 1120 is configured to engage with a striker when the pawl 1120 is in the extended position. In a non-limiting example, the striker is positioned within the compartment or enclosure.

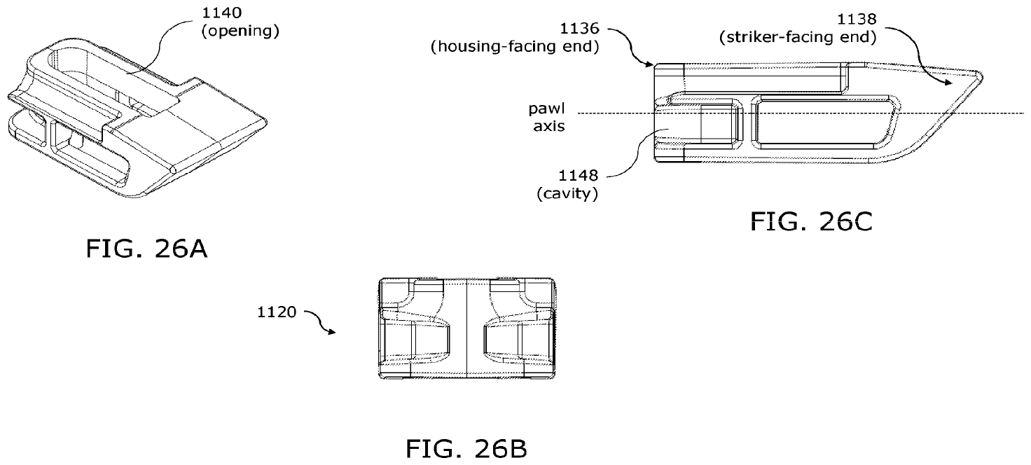

The pawl 1120 moves between the extended position and the retracted position via a biasing means. The biasing means may comprise one or more biasing springs 1134 operating on the pawl 1120 to bias it toward the extended position and permitting push to close operation thereof. As shown in FIG. 21, the one or more biasing springs 1134 is configured to be at least partially enclosed within the pawl 1120 and the housing 1122. In particular, the one or more biasing springs 1134 is positioned along a pawl axis (FIG. 26C) extending from a housing-facing end 1136 and a striker-facing end 1138.

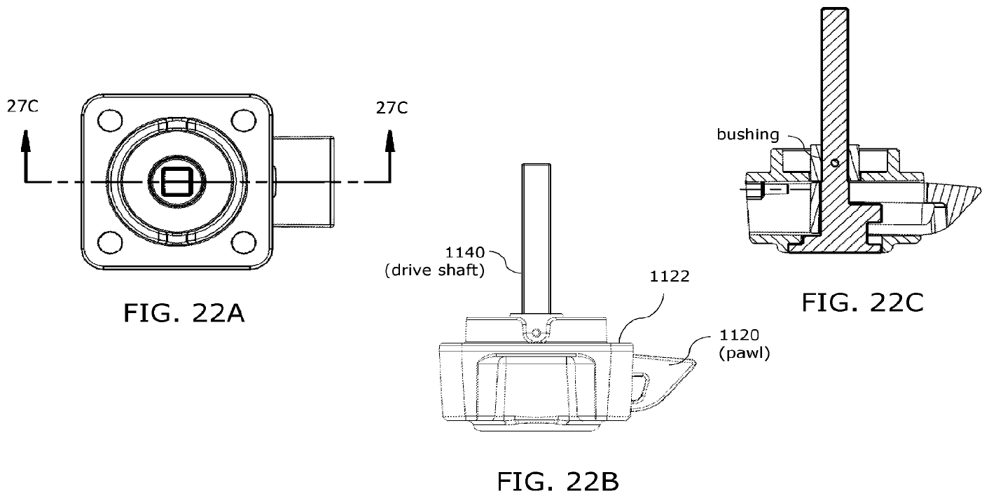

In a non-limiting example, the pawl assembly 1006 also includes the drive shaft 1140 extending through the opening 1128 of the annular portion 1124 of the slam latch body 1122 and through an opening 1140 (FIG. 26A) defined in the pawl 1120. The drive shaft 1140 extends along a drive shaft axis (FIG. 25B) that extends from an actuator-facing end 1142 to a locking end 1144. As seen in FIGS. 22A-22C, the drive shaft axis is perpendicular to the pawl axis. The actuator-facing end 1142 comprises a surface of the drive shaft 1140 that is configured to engage with the actuator 1014. The locking end 1144 comprises at least one wing-like projection 1146 that extends radially outwardly from the shaft axis and is configured to engage with a corresponding cavity 1148 of the pawl 1120 (as seen in FIG. 22C). The at least one-wing like projection 1146 extends radially outwardly in a direction that corresponds to the pawl axis (as illustrated in FIG. 22C). When the wing-like projection 1146 is engaged by the cavity 1148 of the pawl 1120 (as seen in FIGS. 22C and 26A-26C), the drive shaft 1140 and the wing-like projection 1146 together define a path of movement of the pawl 1120 as the pawl 1120 moves between the retracted position and the extended position.

In particular, the path of movement may depend on the position of the pawl 1120 relative to the housing 1122. As seen in FIG. 9B, the pawl 1120 may be positioned in any one of three directions, such as lateral directions 1121a, b and longitudinal direction 1121c, relative to the housing 1122. Specifically, the striker-facing end 1138 of the pawl 1120 may be positioned towards the left (1121b) or towards the right (1121a) relative to the drive shaft 1140 when the latch assembly 1000 is in a vertical or portrait orientation.

In another example, the striker-facing end 1138 of the pawl 1120 is positioned in a downwardly direction when the latch assembly 1000 is in a horizontal or landscape orientation. However, one of ordinary skill in the art would appreciate from the description herein that the striker-facing end 1138 of the pawl 1120 may optionally be positioned in the downwardly direction when the latch assembly 1000 is in the vertical or portrait orientation. In another example, the striker-facing end 1138 of the pawl 1120 may be positioned toward the left or towards the right of the drive shaft 1140 when the latch assembly 1000 is in the horizontal or landscape orientation.

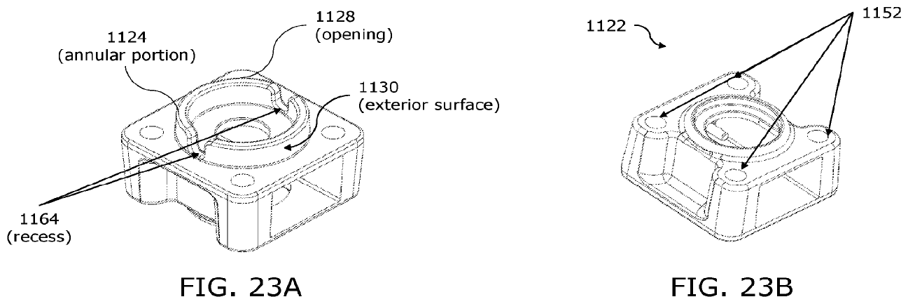

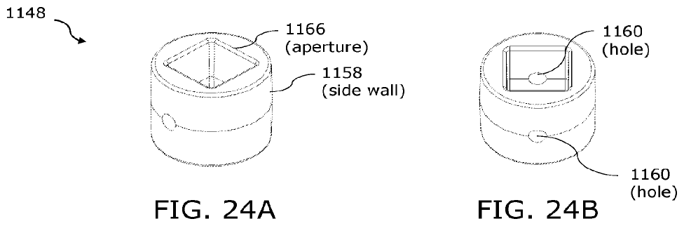

Finally, the pawl assembly 1006 further comprises a bushing 1148 and a cross pin 1150. The bushing 1148 defines a side wall 1158 having a pair of corresponding holes 1160. The pair of holes 1160 have a size and shape that corresponds with the size and shape of a hole 1162 defined by the drive shaft 1140, such that together the pair of holes 1160 of the bushing 1148 and the hole 1162 of the drive shaft 1140 define a passageway through which the cross pin 1150 is configured to extend. As seen in FIG. 22B, the cross pin 1150 is configured to extend through at least one U-shaped recess 1164 (FIG. 23A) defined by the annular portion 1124 of the slam latch body 1122. In this way, the drive shaft 1140 is configured to be in a fixed position relative to the slam latch body 1122 via the cross pin 150 being in contact with the at least one recess 1164, when it extends through the passageway defined by the holes 1160 of the bushing 1148 and the hole 1162 of the drive shaft 1140. Furthermore, the bushing 1148 defines a square aperture 1166 through which the drive shaft 1140 is configured to extend.

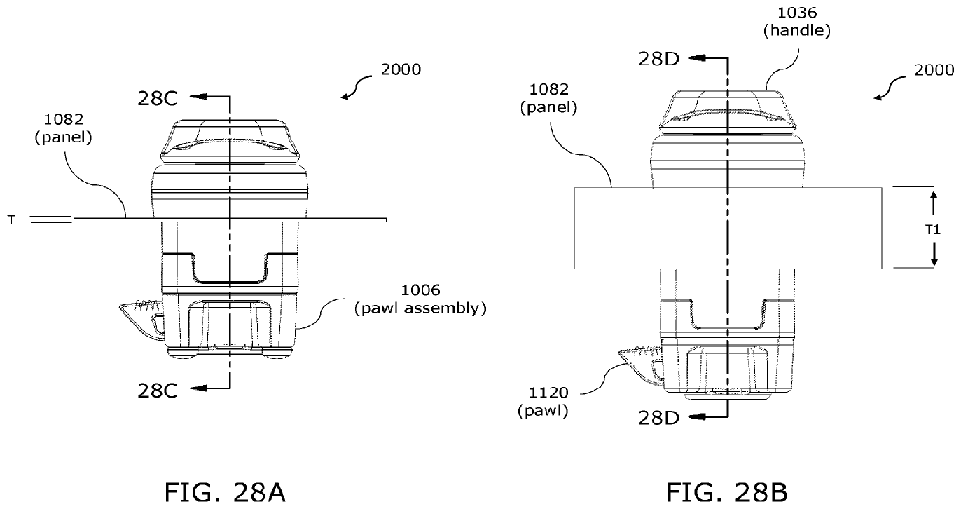

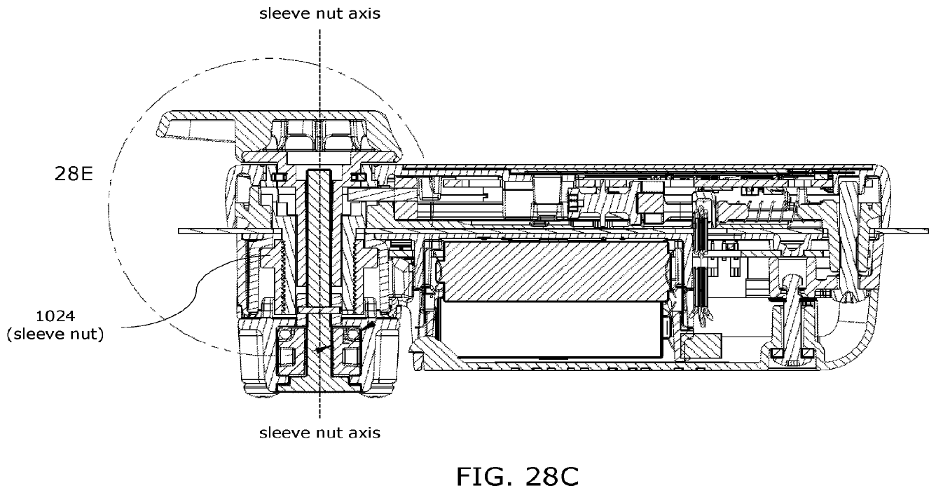

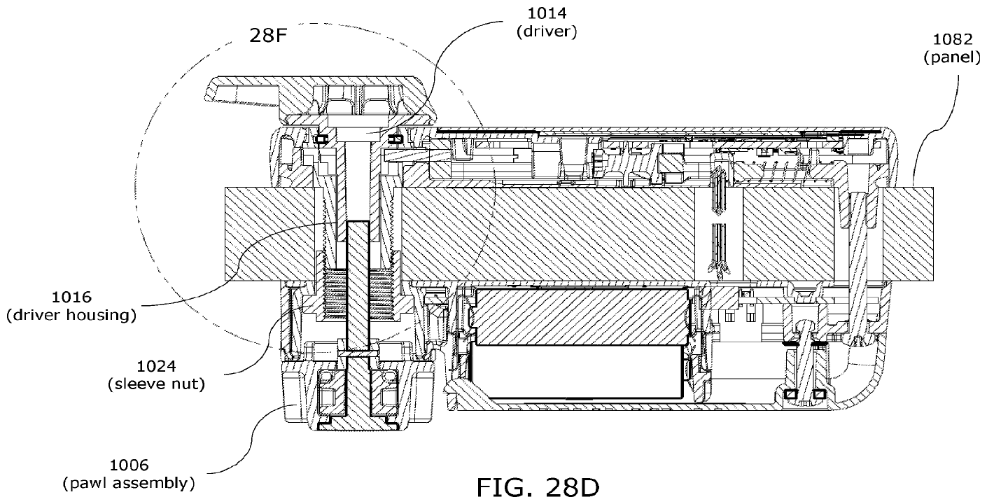

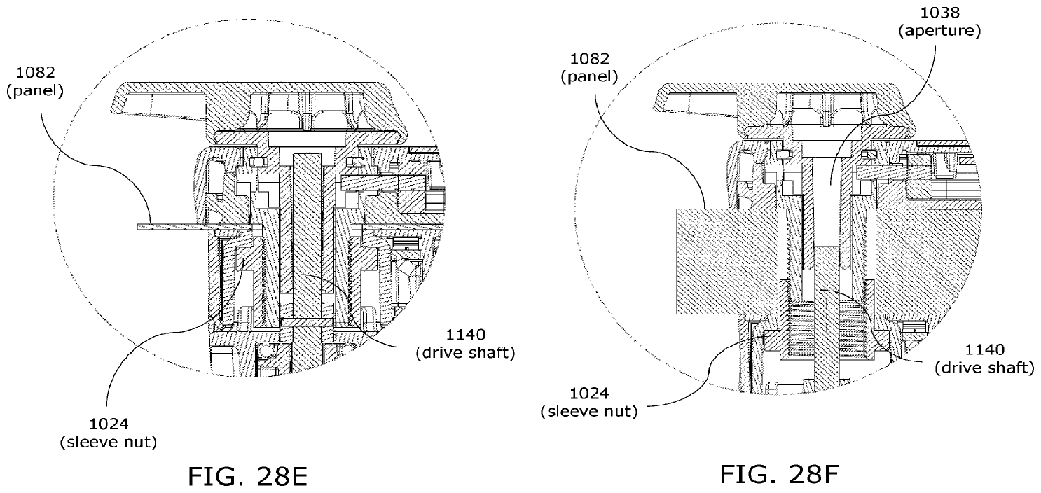

Another embodiment of the latch assembly 1000 made according to the present invention is illustrated in FIGS. 28A-28F and 29A-29D. The components of this second embodiment, such as latch assembly 2000, generally correspond to those of the first embodiment. In this second embodiment, the latch assembly 2000 is configured to be fixed to a panel 1082 having a thickness selected from a range of thicknesses.

Specifically, as seen in FIGS. 28A-28F, the latch assembly 2000 comprises the latch, such as pawl assembly 1006, configured to be positioned on one side of the panel 1082. The pawl assembly 1006 includes a pawl 1120 that is movable between the locked and unlocked positions. On the opposite side of the panel 1082 is positioned at least an actuator, such as the driver 1014. The driver 1014 may be coupled to the handle 1036 and the driver 1014 may be partially enclosed within the driver housing 1016, as illustrated in FIG. 11. Further, the latch assembly 2000 includes the drive shaft 1140 configured for engagement with the pawl assembly 1006, such that rotation of the drive shaft 1140 moves the pawl 1120 between the unlocked and locked positions.

Referring specifically to FIGS. 27A-27B to 29A-29D, the latch assembly 2000 further comprises the sleeve nut 1024 and the sleeve 1126 defining an opening 1168 to receive the sleeve nut 1024. In a non-limiting example, the sleeve 1126 is configured for engagement with the pawl assembly 1006. In general, the sleeve nut 1024 and sleeve 1126 together affix or attach the actuator, such as the driver 1014, to the one side of the panel 1082 and the pawl assembly 1006 to the opposite side of the panel 1082 relative to the actuator 1014. Specifically, the sleeve nut 1024 is configured to be positioned on the side of the panel 1082 and defines an aperture 2002 that extends along a sleeve nut axis (FIG. 28C) for engagement from the opposite side of the panel 1082 on which the actuator 1014 is positioned.

In a non-limiting example, as seen in FIGS. 28C-28D, the engagement surface 1022 of the driver housing 1016 substantially corresponds to the aperture 2002 of the sleeve nut 1024. When the driver housing 1016 and the sleeve nut 1024 are coupled, the actuator, e.g. driver 1014, extends through an aperture 1172 of the driver housing 1016 and the drive shaft 1140 extends through the aperture 1038 of the driver 1014. In particular, as best seen in FIGS. 28E and 28F, the aperture 1038 of the driver 1014 is configured to partially receive the drive shaft 1140, such that a length of the drive shaft 1140 is disposed within the aperture 1038 of the driver 1014.

As seen in FIG. 29A, the sleeve nut 1024 further defines at least one flange portion 2004 extending radially outwardly from the sleeve nut axis (FIG. 28C). The flange portion 2004 is offset along the sleeve nut axis such that there is a first distance (D) from the flange portion 2004 to an actuator-facing end 2006 of the sleeve nut 1024 when the sleeve nut 1024 is in a first orientation (FIGS. 9C, 28E, and 29C). This first distance (D) is smaller than a second distance (D1) from the flange portion 2004 to the actuator-facing end 2006 of the sleeve nut 1024 when the sleeve nut 1024 is in a second orientation (FIGS. 9D, 28F, and 29D). Still further, the sleeve nut 1024 is configured for engagement from the opposite side of the panel 1082 on which the actuator 1014 is positioned when the sleeve nut 1024 is in the first orientation or the second orientation.

As seen in FIGS. 28A-28F, when the sleeve nut 1024 is received by the opening 1168 of the sleeve 1126, such that the actuator 1014 is fixed to the one side of the panel 1082 and the pawl assembly 1006 is fixed to the opposite side of the panel 1082, a portion of the sleeve nut 1024 makes contact with a portion of the sleeve 1126. In particular, each of the at least one flange portion 2004 of the sleeve nut 1024 defines an actuator-facing surface 2008 and the sleeve 1126 includes a pawl-facing surface 2010.

In a non-limiting example, as illustrated in FIGS. 28A, 28C, and 28E, the actuator-facing surface 2008 of the at least one flange portion 2004 is positioned to contact the pawl-facing surface 2010 of the sleeve 1126 when the panel 1082 has a thickness (T) of 0.9 mm to 12 mm and the sleeve nut 1024 is in the first orientation (also seen in FIGS. 9C and 29C).

In another example, as illustrated in FIGS. 28B, 28D, and 28F, the actuator-facing surface 2008 of the at least one flange portion 2004 is positioned to contact the pawl-facing surface 2010 of the sleeve 1126 when the panel 1082 has a thickness (T1) of 12.0 mm to 23 mm and the sleeve nut 1024 is in the second orientation (also seen in FIGS. 9D and 29D). Accordingly, the panel 1082 to which the latch assembly 2000 is configured to be fixed can have a greater thickness, i.e. T1>T when the sleeve nut 1024 is in the second orientation relative to when the sleeve nut 1024 is in the first orientation.

Further, in comparing FIGS. 28E and 28F, when the sleeve nut 1024 is in the first orientation (FIG. 28E), a length of the drive shaft 1140 is disposed within the aperture 1038 of the driver 1014. Conversely, when the sleeve nut 1024 is in the second orientation (FIG. 28F), a relatively shorter length of the drive shaft 1140, relative to the length disposed within the aperture 1038 when the sleeve nut is in the first orientation, is disposed within the aperture 1038 of the driver 1014.

In addition, the latch assembly 2000 may be mounted to the panel via fastening means, such as screws 2012 and 2014. As illustrated in FIGS. 9C and 9D, when the panel 1082 has a thickness of 0.9 mm to 12 mm, screw 2012 is used and the sleeve nut 1024 is in the first orientation. Conversely, when the panel 1082 has a thickness of 12.0 mm to 23 mm, screw 2014, which has a longer length than screw 2012, is used and the sleeve nut 1024 is in the second orientation.

Another embodiment of the latch assembly 1000 made according to the present invention is illustrated in FIGS. 30 and 31A-31C. The components of this third embodiment, such as latch assembly 3000, generally correspond to those of the first and second embodiments, i.e. latch assemblies 1000 and 2000. In this third embodiment, the latch assembly 3000 is configured for mounting to the enclosure defining the secure space in a clean environment. As non-limiting examples, the secure space may be a secure room, a secure cabinet, or a secure cart containing medication.

Specifically, the latch assembly 3000 comprises a housing, such as the actuator assembly 1002 including the bezel sub assembly 1012, configured to be positioned adjacent an exterior surface of the enclosure, such as an exterior surface of the panel 1082. The latch assembly 3000 also includes a sensor port 118 (FIG. 10) that is associated with the housing 1002 and is positioned for coupling a sensor, such as sensor 120, to the latch assembly 3000. The sensor 120 is configured to detect or receive a signal corresponding to a condition associated with the secure space. The conditions, include, but are not limited to a temperature or a humidity within the secure space.

Information relating to the conditions within the secure space, such as the conditions detected by the sensor 120, is then displayed via a display, such as display 102. Specifically, the display 102 is associated with the housing 1002 for displaying information relating to the conditions within the secure space. The display 102 may be an electronic ink display, which advantageously conserves or reduces the required power used to operate the latch assembly 3000. Additionally or optionally, the display 102 may be configured to display at least an icon, image, or message. The at least one icon, image or message may relate to one or more of a time, a date, a logo, a signal status, a power status, a connection status, a location, and a network status.

An advantage of this embodiment makes possible the reduction or mitigation of ingress or collection of unwanted materials, e.g. dust, contaminants, moisture, etc., into the housing, such as the housing 1002 comprising the base sub assembly 1008 and bezel sub assembly 1012. In a non-limiting example, as seen in FIG. 30, the display 102 is configured to be received by a display-receiving recess 3006 defined by a bezel 3004 of the bezel sub assembly 1012. Additionally or optionally, a translucent protective cover, such as a display fascia 3008, is configured to be received by a cover-receiving recess 3010 defined by the bezel 3004, thereby enclosing the display 102. Specifically, the translucent protective cover 3008 is positioned to cover the display 102. Advantageously, the translucent protective cover 3008 is sealed to the bezel 3004, thereby resisting ingress of unwanted materials into the housing 1002.

Still further, the translucent protective cover 3008 has a thickness that corresponds to the depth of the cover-receiving recess 3010, such that a cover exterior surface 3012 of the translucent protective cover 3008 is substantially coplanar with a housing exterior surface 3014 of the housing 1002. In this way, a further advantage of the present invention is that the translucent protective cover 3008 and the exterior surface 3014 of the housing 1002 together inhibit the ingress of unwanted materials into the housing 1002.

In another example, the latch assembly 3000 further comprises a gasket 3016 (FIG. 15) configured to be interposed between the housing 1002 and the exterior surface of the enclosure, such as the exterior surface of the enclosure having the panel 1082, for creating a seal between the housing 1002 and the exterior surface of the enclosure. In this way, the translucent protective cover 3008, the housing exterior surface 3014, and the gasket 3016 together inhibit the ingress of unwanted materials into the housing 1002.

To facilitate the display of information relating to the condition associated with the secure space, the sensor 120 is electrically connected to the processor, such as printed circuit board 1066 or printed circuit board assembly 1104. Optionally, the processor, such as processor 1104, may be disposed within the housing 1002 or within another component of the latch assembly 3000, such as the battery box assembly 1004.

Additionally or optionally, the display 102 may be configured to display information relating to the operation of the latch assembly 3000. In a non-limiting example, the housing 1002 further comprises a wireless transceiver 108 disposed within the housing 1002 and the wireless transceiver 108 is configured to perform wireless communication with wireless devices that are external to the latch assembly 3000. The display 102 is disposed in the display-receiving recess 3006, such that the display 102 is proximate the wireless transceiver 108 and the information relating to the operation of the latch assembly 3000 includes an instruction that indicates placement of a user credential (e.g. RFID credential 206C) relative to the display 102. For example, as seen in FIG. 1, the instruction may comprise RFID tap point 122.

Another embodiment of the latch assembly 1000 made according to the present invention is illustrated in FIGS. 9B, 32A-32B, and 33. The components of this fourth embodiment, such as latch assembly 4000, generally correspond to those of the first embodiment. In this fourth embodiment, the latch assembly 4000 is configured for use with an enclosure having a panel, such as panel 1082, and a frame. The latch assembly 4000 is further configured for latching the panel 1082 relative to the frame. Further, the frame may be configured to have a magnetized striker mounted thereon.

The latch assembly 4000 comprises a latch, such as pawl assembly 1006, the panel 1082 or the frame. The latch 1006 may further include a pawl, such as ramp ended pawl 1120, that is movable between an engaged position and a disengaged position. In the engaged position, the pawl 1120 is configured to engage the striker. Conversely, in the disengaged position, the pawl 1120 is configured to not engage the striker.

The striker may be magnetized, such that the striker may have one or more magnets, the one or more magnets generating a magnetic field. Additionally or optionally, the striker may be fitted with a sleeve or other like structures, the sleeve being configured to contain one or more magnets. Suitable means of providing a magnetized striker on the frame or the panel 1082 will be known to a person of ordinary skill in the art based on the description herein. In a non-limiting example, the latch is configured for mounting to the panel 1082 or the frame in multiple predetermined orientations relative to the striker mounted on the other one of the panel 1082 or the frame.

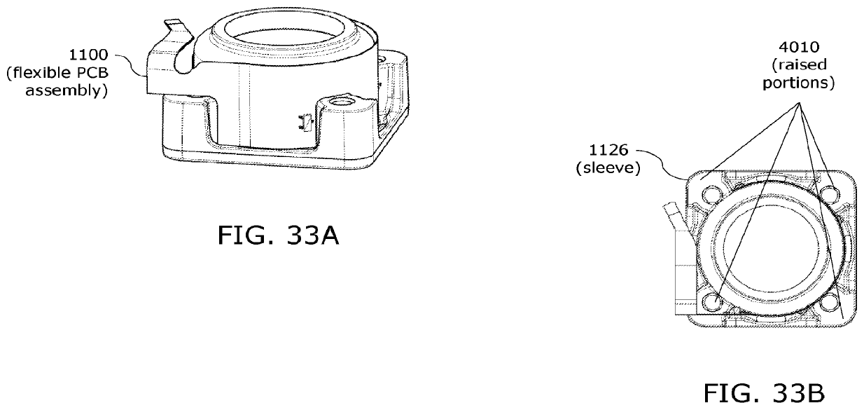

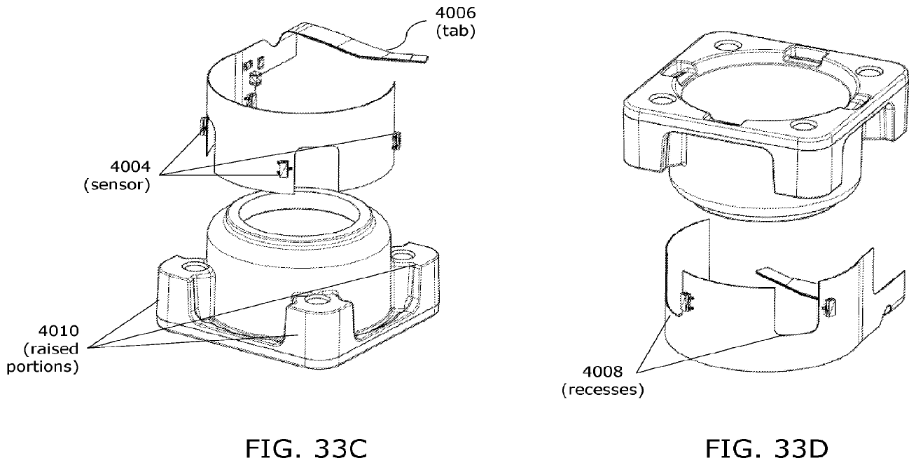

As seen in FIGS. 33A-33D, a sleeve defining an annular portion, such as the sleeve 1126 defining annular portion 4002, may be coupled to the latch 1006. Sleeve 1126 may have a rectangular or square geometry, such that sleeve 1126 defines a plurality of raised portions 4010 surrounding the annular portion 4002 in a generally symmetrical configuration. As best shown in FIGS. 33A-33B, a flexible substrate, such as a flexible printed circuit board 1100, may circumscribe a surface of the annular portion 4002 of the sleeve 1126. Specifically, the flexible printed circuit board 1100 may be wrapped around the surface of the annular portion 4002 of the sleeve 1126, such that the flexible printed circuit board 1100 is wrapped around an axis, such as the sleeve nut axis (FIG. 28C). Still further, the flexible printed circuit board 1100 may define one or more U-shaped recesses 4008 that is configured to correspond to the size and shape of the plurality of raised portions 4010 of the sleeve 1126, such that the flexible printed circuit board 1100 may be positioned or secured around the annular portion 4002 of the sleeve 1126.

Further, the flexible printed circuit board 1100 is configured to be in electrical communication with a printed circuit board assembly, such as printed circuit board assembly 1104 (FIG. 20). In particular, flexible printed circuit board 1100 includes a free end portion, such as tab 4006, configured to make contact with printed circuit board assembly 1104. The tab 4006 may be connected to printed circuit board assembly 1104 when retaining feature 4012 of the printed circuit board assembly 1104 secures at least a portion of tab 4006. In a non-limiting example, the attachment of or contact between retaining feature 4012 and at least a portion of tab 4006 may be a snap-in arrangement. Other attachment means will be known to a person of ordinary skill in the art based on the description herein. Specifically, flexible printed circuit board 1100 is wrapped around the surface of the annular portion 4002 of the sleeve 1126, such that tab 4006 is configurable to be disposed above one or more of the raised portions 4010 of the sleeve 1126. In other words, the flexible tab 4006 may be positionable or manipulated to fold over a portion of the sleeve 1126, such that tab 4006 can be connected to or secured by the printed circuit board assembly 1104. This electrical communication between flexible printed circuit board 1100 and printed circuit board assembly 1104 facilitates the operation of sensors 4004 (discussed below).

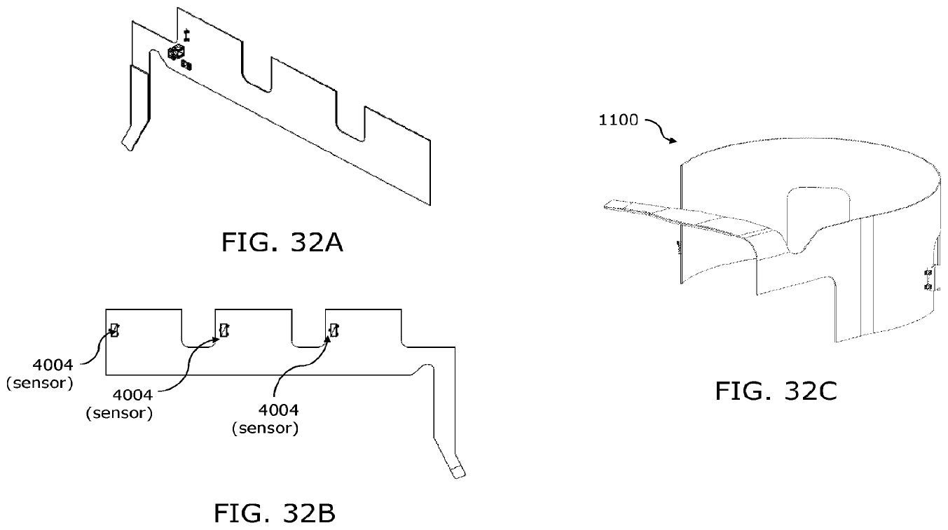

Referring now to FIGS. 32A-32C and 33A-33D, the sensors 4004 may be mounted on a flexible substrate, such as a surface of flexible printed circuit board 1100. Sensors 4004 may be mounted on a surface of flexible printed circuit board 1100 by any mounting means, such as soldering. In a non-limiting example, the sensors 4004 may be spatially distributed on the flexible printed circuit board 1100, such that each of the sensors 4004 may be positioned adjacent the annular portion 4002 of the sleeve 1126 at different radial locations. Further, the sensors 4004 may be positioned to correspond to the location of the magnetized striker, such that each of the sensors 4004 are configured to detect the striker when the sensor 4004 is proximal to the striker. Still further, one of the sensors 4004 mounted on the flexible substrate 1100 may be positioned to detect the striker in each of the predetermined orientations of the latch 1006. As a non-limiting example and as illustrated in FIGS. 9B and 32B, one of the sensors 4004 corresponds to a lateral (left, right) orientation of the latch 1006 relative to the latch body 1122 and a longitudinal (down) orientation of the pawl 1120 relative to the latch body 1122.

It should be understood from the description herein that the sensors 4004 are capable of detecting the striker independent of the orientation of the latch 1006 relative to the striker, or independent of the pawl 1120 relative to the latch body 1122. In other words, the sensors 4004 are capable of detecting the striker when the latch 1006 is proximal to the striker.

Additionally or optionally, the sensors 4004 are capable of detecting the magnetic field generated by the magnetized striker when the latch 1006 engages the magnetized striker.

Still further, the latch 1006 may be configured to be mounted on the panel 1082 or the frame in any one of a plurality of orientations. As a non-limiting example and as illustrated in FIG. 32B, the latch 1006 may have a lateral (left, right) orientation or a longitudinal (down) orientation. Still further, the pawl 1120 of latch 1006 is movable generally within a plane parallel to the striker. Additionally or optionally, the pawl 1120 of latch 1006 is movable generally transverse to a plane parallel to the striker.

As a non-limiting example, the sensors 4004 comprise a Hall effect sensor positionable to detect the magnetized striker when the latch 1006 is proximal to the striker.

In yet another embodiment of the present invention, a latch system is disclosed. Specifically, the latch system is configured for use with a plurality of enclosures defining secure spaces each in a sterile environment and a plurality of latch assemblies, such as latch assembly 3000, each latch assembly 3000 being configured for mounting to a respective enclosure defining a respective secure space

Generally, the components of the latch system corresponds to those of the third embodiment. The respective secure space is a secure room, a secure cabinet or a secure cart, and the condition is a temperature or humidity within the secure space. The display, such as display 102, is configured for displaying information relating to operation of the latch assembly, such as latch assembly 3000. Additionally or optionally, the display 102 may be configured for displaying information relating to the respective enclosure to which the latch assembly 3000 is configured to be mounted.

Further, each latch assembly 3000 comprises a processor, such as processor 1066 or 1104, and a wireless transceiver disposed within the housing 1002. The wireless transceiver 108 is configured for performing wireless communication with wireless devices that are external to the latch assembly 3000. Still further, the display 102 is proximate the wireless transceiver 108 and the information relating to the operation of the latch assembly 3000 includes an instruction that indicates placement of a user credential (e.g. RFID credential 206C) relative to the display 102. For example, as seen in FIG. 1, the instruction may comprise RFID tap point 122.

The display 102 may be an electronic ink display, which advantageously conserves or reduces the required power used to operate the latch assembly 3000. Additionally or optionally, the display 102 may be configured to display at least an icon, image, or message. The at least one icon, image or message may relate to one or more of a time, a date, a logo, a signal status, a power status, a connection status, a location, and a network status.

Each latch assembly 3000 may further include a gasket, such as gasket 3016 (FIG. 15), configured to be interposed between the respective housing 1002 and the respective enclosure, such as the enclosure having the panel 1082, for creating a seal between the respective housing 1002 and the respective enclosure. In this way, a translucent protective cover, such as translucent protective cover 3008, a housing exterior surface, such as housing exterior surface 3014, and the gasket 3016 together inhibit the ingress of unwanted materials into the respective housing 1002.

In still another embodiment of the present invention, the components of this sixth embodiment of the latch assembly 1000 generally correspond to those of the third and fourth embodiments, i.e. latch assembly 3000 and latch assembly 4000. In this sixth embodiment, the latch assembly 3000, 4000 is configured for mounting to an enclosure defining a secure space. As non-limiting examples the secure space may be a secure room, a secure cabinet, or a secure cart containing medication.

The latch assembly 3000, 4000 comprises a housing, such as the actuator assembly 1002 including the bezel sub assembly 1012, configured to be positioned adjacent an exterior surface of the enclosure, such as an exterior surface of the panel 1082, in one of multiple orientations. The latch assembly 3000, 4000 further comprises a pawl assembly, such as pawl assembly 1006, which comprises a pawl, such as pawl 1120, that is movable between locked and unlocked positions. The pawl 1120 is positionable in one of multiple pawl orientations depending on the orientation of the housing 1002. The pawl assembly 1006 is further coupled to an actuator, such as actuator 1014. The actuator 1014 is movable relative to the housing 1002 and is coupled for actuation of the pawl assembly 1006.

Further, the latch assembly 3000/4000 further comprises a display associated with the housing 1002, such as display 102, for displaying information relating to operation of the latch assembly 3000/4000. The information relating to operation of the latch assembly 3000/4000 includes status information and a placement instruction located in a position indicative of placement of a user credential (e.g. RFID credential 206C) relative to the display 102. The display 102 is further configured to reorient the status information relative to the housing 1002 depending on the orientation of the housing 1002. Still further, the display 102 is configured to maintain the position of the placement instruction relative to the housing 1002 independent of the orientation of the housing 1002.

As a non-limiting example, the placement instruction comprises an icon (e.g. RFID tap point 122) indicative of placement of the user credential 206C relative to the display 102. Additionally or optionally, the display 102 is configured to reorient the icon 122 relative to the housing 1002 depending on the orientation of the housing 1002 while maintaining the position of the icon, image, or message 122 relative to the housing 1002 independent of the orientation of the housing 1002. As a non-limiting example, the display 102 is configured to rotate the icon 122 relative to the housing 1002 depending on the orientation of the housing 1002 while maintaining the position of the icon 122 relative to the housing 1002 independent of the orientation of the housing 1002.

In another example, the display 102 is configured to display status information including at least one of an icon, an image, or a message. The at least one of the icon, the image, or the message relates to one or more of a time, a date, a logo, a signal status, a power status, a connection status, a location, and a network status. Additionally or optionally, the display 102 is configured to reorient the status information relative to the housing 1002 depending on the orientation of the housing 1002 while maintaining the position of placement instruction relative to the housing 1002 independent of the orientation of the housing 1002. As a non-limiting example, the display 102 is configured to rotate the icon 122 relative to the housing 1002 depending on the orientation of the housing 1002 while maintaining the position of the icon 122 relative to the housing 1002 independent of the orientation of the housing 1002.

As a non-limiting example, latch assembly 3000/4000 may include an internal sensor, such as an accelerometer, that determines orientation of the latch 1006. This is important, because the latch 1006 may be installed in different orientations (up, down, left and right) depending on the configuration of at least the pawl 1120. By including an accelerometer, the latch assembly 3000/4000 is able to determine its orientation and adjust the orientation of the data or information visible to a user via display 102. Specifically, the accelerometer permits the latch assembly 3000/4000 to rotate icon 122 relative to the housing 1002 depending on the orientation of the housing 1002, while maintaining the position of the icon 122 relative to the housing 1002 independent of the orientation of the housing 1002.

The methods and materials used to fabricate the components of a latch assembly according to the present invention may be any materials known to those having skill in the art. For example, in some embodiments, a stronger, rugged metal material for the latch cam and trigger may be desired to ensure that the latch mechanism will operate properly for a number of cycles during the lifetime of the latch mechanism. For cost reasons, some embodiments may use a cam and/or trigger made from plastic materials. The various components may be stamped from metal or injection molded from plastic, for example.

Aspects of the invention include:

1. A wireless latch assembly comprising:
a latch configured for latching a secure space;
a display, local to the latch, configured to display information;
a sensor port positioned for coupling a sensor to the wireless latch assembly and configured for receiving a signal corresponding to a condition associated with the secure space;
a wireless transceiver configured for performing wireless communication with one or more wireless components external to the wireless latch assembly;
a processor coupled to the display and to the wireless transceiver, the processor being configured to:
   display, via the display, information relating to operation of the wireless latch assembly and the condition associated with the secure space,
   receive, via the wireless transceiver, a plurality of credentials relating to access to the secure space,
   detect, via the wireless transceiver, a user credential of a user requesting access to the secure space,
   compare the user credential of the user to the plurality of credentials to determine when the user credential is valid, and
   enable operation of the latch to permit access to the secure space when it is determined that the user credential is valid.

2. The wireless latch assembly of aspect 1, wherein the wireless transceiver is configured to receive the plurality of credentials as a push from an administrator.

3. The wireless latch assembly of aspect 1, wherein the wireless transceiver is configured to detect the user credential via an RFID card or a smart device possessed by the user.

4. The wireless latch assembly of aspect 3, wherein when the wireless transceiver detects the user credential via the RFID card or the smart device, the user credential is refreshed on the RFID card or the smart device.

5. The wireless latch assembly of aspect 3, wherein when the wireless transceiver detects the user credential via the RFID card or the smart device, the user credential is stored in an audit trail.

6. The wireless latch assembly of aspect 3, wherein the wireless transceiver is configured to receive a black list of credentials as a push from an administrator indicating that the credentials on the black list are no longer valid to permit access to the secure space.

7. The wireless latch assembly of aspect 3, wherein the wireless transceiver is configured to receive a new plurality of credentials as a push from an administrator excluding the user credential when the user is no longer permitted access to the secure space.

8. The wireless latch assembly of aspect 3, wherein the wireless transceiver is configured to communicate with a hub that services a plurality of wireless latch assemblies, the wireless transceiver being configured to receive the plurality of credentials from the hub or instructions from the hub to enable a user to unlatch the latch for access to the secure space.

9. The wireless latch assembly of aspect 1, wherein the secure space is a secure room, a secure cabinet, a secure cart, or a compartment thereof, and the condition is a temperature or a humidity within the secure space.

10. The wireless latch assembly of aspect 1, wherein the wireless latch assembly is capable of operating independently and the processor is further configured to perform the detecting, the comparing and the enabling steps without wireless communication with external components.

11. The wireless latch assembly of aspect 1, wherein the processor is further configured to perform dual authentication by:
repeating the detecting and the comparing steps with an additional user credential, and
enabling the user to unlatch the latch for access to the secure space when it is determined that the user credential and the additional user credential are both valid.

12. A wireless latch system comprising:
a server;
a communication hub configured for communication with the server;
an administrator computer configured for communication with the communication hub; and
at least one wireless latch assembly including:
   a latch configured for latching a secure space,
   a display, local to the latch, configured to display information,
   a sensor port positioned for coupling a sensor to the wireless latch assembly and configured for receiving a signal corresponding to a condition associated with the secure space,
   a wireless transceiver configured for performing wireless communication with one or more wireless components external to the wireless latch assembly, and
   a processor coupled to the display and to the wireless transceiver, the processor being configured for controlling the wireless latch;
      wherein the administrator computer is configured to transmit to the server a plurality of credentials and a latch identification corresponding to the at least one wireless latch assembly, the plurality of credentials relating to access of the secure space secured by the at least one wireless latch assembly;
      wherein the server is configured to store the plurality of credentials and communicate the plurality of credentials and the latch identification to the communication hub;
      wherein the communication hub is configured to push the plurality of credentials to the at least one wireless latch assembly that corresponds to the latch identification;
      wherein the processor of the wireless latch assembly is configured to:
display, via the display, information relating to operation of the wireless latch assembly and information relating to the condition associated with the secure space,
receive, via the wireless transceiver, the plurality of credentials,
detect, via the wireless transceiver, a user credential of the user requesting access to the secure space,
compare the user credential of the user to the plurality of credentials to determine when the user credential is valid, and
enable operation of the latch to unlock the secure space when it is determined that the user credential is valid.

13. The wireless latch system of aspect 12, further comprising plural wireless latch assemblies, wherein the administrator computer is configured to transmit to the server a plurality of credentials and a latch identification corresponding to a selected wireless latch assembly, the plurality of credentials relating to access of the secure space secured by the selected wireless latch assembly;
wherein the server is configured to store the plurality of credentials and communicate the plurality of credentials and the latch identification to the communication hub; and
wherein the communication hub is configured to push the plurality of credentials to the selected wireless latch assembly.

14. A latch assembly configured for mounting to an enclosure securing a secure space, the latch assembly comprising:
a housing;
an actuator mounted for movement relative to the housing;
a latch coupled to the actuator and movable between a latched condition and an unlatched condition;
a slide movable relative to the housing between a retracted position and an extended position, the slide being configured for engagement with the actuator in the extended position and being configured for disengagement from the actuator in the retracted position, the slide including a locking pin positioned for engagement by a locking groove of the actuator when the slide is in the extended position and for disengagement from the locking groove of the actuator when the slide is in the retracted position;
a biasing spring operating on the slide to bias the slide toward the extended position;
a drive cam mounted for rotation relative to the housing and adjacent the slide, the drive cam being configured to move the slide against the biasing spring operation and toward the retracted position;
wherein when the locking pin is engaged by the locking groove, the locking pin is in a fixed position relative to the actuator, and the locking pin and the actuator together prevent access to the secure area.

15. The latch assembly of aspect 14, further comprising a motor, wherein the slide defines a contact surface configured to guide movement of the slide relative to the drive cam and the drive cam comprises a motor-facing end configured for engagement by the motor and a contact-surface-facing end configured for engagement by the contact surface of the slide.

16. The latch assembly of aspect 15, wherein the drive cam is configured to rotate when the motor is activated.

17. The latch assembly of aspect 16, wherein the drive cam is rotatable about a drive cam axis that extends between the contact surface-facing end and the motor-facing end of the drive cam.

18. The latch assembly of aspect 16, the drive cam axis being substantially parallel to the biasing spring operation.

19. The latch assembly of aspect 15, further comprising a processor configured to control the motor.

20. The latch assembly of aspect 19, further comprising at least one sensor coupled to the processor and positioned to detect the drive cam.

21. The latch assembly of aspect 20, wherein the drive cam comprises at least one projection that extends radially outwardly from the drive cam axis.

22. The latch assembly of aspect 21, wherein the at least one sensor includes a proximity sensor configured to detect the at least one projection of the drive cam.

23. The latch assembly of aspect 21, wherein the at least one sensor is positioned to detect the at least one projection as the drive cam rotates about the drive cam axis.

24. The latch assembly of aspect 21, wherein the at least one sensor is mounted to a surface and the surface defines a slot adjacent to the at least one sensor, the slot having a size and shape to accommodate the at least one projection of the drive cam.

25. The latch assembly of aspect 20, further comprising a power supply and a cable extending from the power supply to the motor.

26. The latch assembly of aspect 25, wherein the power supply includes an integrated power source with one or more batteries.

27. The latch assembly of aspect 26, further comprising a plurality of batteries, wherein the batteries are stacked or arranged in a substantially triangular geometry.

28. The latch assembly of aspect 19, wherein the housing defines an access port configured for engagement with a connector, the access port being configured to facilitate the delivery of power or signals to or from an external device.

29. The latch assembly of aspect 28, wherein the external device is a power source.

30. The latch assembly of aspect 28, wherein the housing includes an ingress protection plug having a tether and a releasable cover, the releasable cover being movable for access to the access port.

31. A latch assembly configured to be fixed to a panel having a thickness selected from a range of thicknesses, the latch assembly comprising:
a pawl assembly configured to be positioned on a side of the panel, the pawl assembly comprising a pawl that is movable between locked and unlocked positions;
an actuator configured to be positioned on an opposite side of the panel relative to the pawl assembly;
a drive shaft configured to couple the actuator to the pawl assembly such that rotation of the drive shaft by the actuator moves the pawl between the locked and unlocked positions;
a sleeve nut configured to be positioned on the side of the panel and defining an aperture extending along a sleeve nut axis for engagement from the opposite side of the panel on which the actuator is positioned, the sleeve nut having a flanged portion extending radially outwardly from the sleeve nut axis, the flanged portion being offset along the sleeve nut axis such that a first distance from the flanged portion to an actuator-facing end of the sleeve nut in a first orientation of the sleeve nut is smaller than a second distance from the flanged portion to an actuator-facing end of the sleeve nut in a second orientation of the sleeve nut;
the sleeve nut being configured for engagement from the opposite side of the panel on which the actuator is positioned when the sleeve nut is in the first orientation or in the second orientation; and
the latch assembly being configured to be fixed to a panel having a greater thickness when the sleeve nut is in the second orientation relative to when the sleeve nut is in the first orientation.

32. The latch assembly of aspect 31, wherein the drive shaft extends from the pawl assembly and the actuator defines an aperture for receiving the drive shaft.

33. The latch assembly of aspect 31, further comprising a sleeve configured for engagement with the pawl assembly and defining an opening to receive the sleeve nut, wherein the flange portion of the sleeve nut in the first orientation has an actuator-facing surface positioned to contact a pawl-facing surface of the sleeve when the panel has a thickness of 0.9 mm to 12 mm.

34. The latch assembly of aspect 31, further comprising a sleeve configured for engagement with the pawl assembly and defining an opening to receive the sleeve nut, wherein the flange portion of the sleeve nut in the second orientation has an actuator-facing surface positioned to contact a pawl-facing surface of the sleeve when the panel has a thickness of 12.0 mm to 23 mm.

35. A latch assembly configured for mounting to an enclosure defining a secure space in a clean environment, the latch assembly comprising:
a housing configured to be positioned adjacent an exterior surface of the enclosure,
a sensor port associated with the housing, positioned for coupling a sensor to the latch assembly, and configured for receiving a signal corresponding to a condition associated with the secure space;
a display associated with the housing for displaying information relating to the condition associated with the secure space; and
a translucent protective cover positioned to cover the display;
wherein the housing defines a display-receiving recess configured to receive the display and a cover-receiving recess configured to receive the translucent protective cover, thereby enclosing the display, the translucent protective cover being sealed to the housing to resist ingress of unwanted materials into the housing; and
wherein the translucent protective cover has a thickness corresponding to a depth of the cover-receiving recess such that a cover exterior surface of the translucent protective cover is substantially flush with a housing exterior surface of the housing to reduce collection of unwanted materials and to facilitate removal of unwanted materials from the housing exterior surface, the translucent protective cover and the housing exterior surface together inhibiting the ingress of unwanted materials into the housing.

36. The latch assembly of aspect 35, wherein the secure space is a secure room, a secure cabinet, or a secure cart, and the condition is a temperature or a humidity within the secure space.

37. The latch assembly of aspect 35, wherein the display is configured for displaying information relating to operation of the latch assembly.

38. The latch assembly of aspect 37, further comprising a processor and a wireless transceiver disposed within the housing, the wireless transceiver being configured for performing wireless communication with wireless devices external to the latch assembly.

39. The latch assembly of aspect 38, wherein the display is disposed proximate to the wireless transceiver and the information relating to operation of the latch assembly includes an instruction for placement of a user credential relative to the display.

40. The latch assembly of aspect 35, wherein the display is an electronic ink display.

41. The latch assembly of aspect 35, wherein the display is configured to display at least one of an icon, an image, or a message, the at least one of the icon, the image, or the message relating to one or more of a time, a date, a logo, a signal status, a power status, a connection status, a location, and a network status.

42. The latch assembly of aspect 35, further comprising a gasket configured to be interposed between the housing and the exterior surface of the enclosure for creating a seal between the housing and the exterior surface of the enclosure, wherein the translucent protective cover, the housing exterior surface, and the gasket together inhibit the ingress of unwanted materials into the housing.

43. A latch system configured for use with a plurality of enclosures defining respective secure spaces each in a sterile environment, the latch system comprising plural latch assemblies according to aspect 35, each of the latch assemblies being configured for mounting to a respective enclosure to secure a respective secure space.

44. The latch system of aspect 43, wherein the respective secure space is a secure room, a secure cabinet or a secure cart, and the condition is a temperature or a humidity within the secure space.

45. The latch system of aspect 43, wherein the display is configured for displaying information relating to operation of the latch assembly and the respective enclosure to which the latch assembly is configured to be mounted.

46. The latch system of aspect 45, each latch assembly further comprising a processor and a wireless transceiver disposed within the housing, the wireless transceiver being configured for performing wireless communication with wireless devices external to the latch assembly.

47. The latch system of aspect 46, wherein the display is disposed proximate to the wireless transceiver and the information relating to operation of the latch assembly includes an instruction indicative of placement of a user credential relative to the display.

48. The latch system of aspect 43, wherein the display is an electronic ink display.

49. The latch system of aspect 43, wherein the display is configured to display at least one of an icon, an image, or a message, the at least one of the icon, the image, or the message relating to one or more of a time, a date, a logo, a signal status, a power status, a connection status, a location, and a network status.

50. The latch system of aspect 43, each latch assembly further comprising a gasket to be interposed between the housing and the respective enclosure for creating a seal between the housing and the respective enclosure, and the translucent protective cover, the housing exterior surface, and the gasket together inhibit the ingress of unwanted materials into the housing.

51. A latch assembly configured for use with an enclosure having a panel and a frame and for latching the panel relative to the frame, the panel or the frame including a magnetized striker, the latch assembly comprising:
a latch configured for mounting to the panel or the frame in multiple predetermined orientations relative to the striker mounted on the other one of the panel or the frame;
a sleeve coupled to the latch, the sleeve having an annular portion;
a flexible substrate circumscribing the annular portion of the sleeve;
sensors mounted on the flexible substrate, each of the sensors being positioned adjacent the annular portion of the sleeve at different radial locations, each of the sensors configured to detect the striker when the sensor is proximal to the striker, and one of the sensors mounted on the flexible substrate being positioned to detect the striker in each of the predetermined orientations of the latch.

52. The latch assembly of aspect 51, wherein the sensors comprise a Hall effect sensor.

53. The latch assembly of aspect 51, the latch also having a pawl movable between an engaged position and a disengaged position, the pawl being configured to engage the striker in the engaged position.

54. The latch assembly of aspect 53, wherein the pawl is movable generally within a plane parallel to the striker.

55. The latch assembly of aspect 53, wherein the pawl is movable generally transverse to a plane parallel to the striker.

56. The latch assembly of aspect 53, wherein the pawl is a ramp ended pawl.

57. The latch assembly of aspect 51, further comprising a housing configured to be mounted to an opposite side of the panel or the frame relative to the latch, an actuator mounted for movement relative to the housing, wherein the actuator is coupled to the latch and is configured to move the latch between unlatched and latched conditions.

58. A latch assembly configured for mounting to an enclosure defining a secure space, the latch assembly comprising:
a housing configured to be positioned adjacent an exterior surface of the enclosure in one of multiple orientations;
a pawl assembly coupled to an actuator and comprising a pawl that is movable between locked and unlocked positions, the pawl being positionable in one of multiple pawl orientations depending on the orientation of the housing;
an actuator movable relative to the housing and coupled for actuation of the pawl assembly;
a display associated with the housing for displaying information relating to operation of the latch assembly, the information including status information and a placement instruction located in a position indicative of placement of a user credential relative to the display, the display being configured to reorient the status information relative to the housing depending on the orientation of the housing, and the display being configured to maintain the position of the placement instruction relative to the housing independent of the orientation of the housing.

59. The latch assembly of aspect 58, the placement instruction comprising an icon located in the position indicative of placement of the user credential relative to the display.

60. The latch assembly of aspect 59, the display being configured to reorient the icon relative to the housing depending on the orientation of the housing, and the display being configured to maintain the position of the icon relative to the housing independent of the orientation of the housing.

61. The latch assembly of aspect 60, the display being configured to rotate the icon relative to the housing depending on the orientation of the housing while maintaining the position of the icon relative to the housing independent of the orientation of the housing.

62. The latch assembly of aspect 58, the display being configured to display status information including at least one of an icon, an image, or a message, the at least one of the icon, the image, or the message relating to one or more of a time, a date, a logo, a signal status, a power status, a connection status, a location, and a network status.

63. The latch assembly of aspect 62, the display being configured to reorient the status information depending on the orientation of the while maintaining the position of the placement instruction relative to the housing independent of the orientation of the housing.

While preferred embodiments of the invention have been shown and described herein, it will be understood that such embodiments are provided by way of example only. Numerous variations, changes and substitutions will occur to those skilled in the art without departing from the spirit of the invention. Accordingly, it is intended that the appended claims cover all such variations as fall within the spirit and scope of the invention.

1. A wireless latch assembly comprising:
a latch configured for latching a secure space;
a display, local to the latch, configured to display information;
a sensor port positioned for coupling a sensor to the wireless latch assembly and configured for receiving a signal corresponding to a condition associated with the secure space;
a wireless transceiver configured for performing wireless communication with one or more wireless components external to the wireless latch assembly;
a processor coupled to the display and to the wireless transceiver, the processor being configured to:
display, via the display, information relating to operation of the wireless latch assembly and the condition associated with the secure space,
receive, via the wireless transceiver, a plurality of credentials relating to access to the secure space,
detect, via the wireless transceiver, a user credential of a user requesting access to the secure space,
compare the user credential of the user to the plurality of credentials to determine when the user credential is valid, and
enable operation of the latch to permit access to the secure space when it is determined that the user credential is valid.

2. The wireless latch assembly of claim 1, wherein the wireless transceiver is configured to receive the plurality of credentials as a push from an administrator.

3. The wireless latch assembly of claim 1, wherein the wireless transceiver is configured to detect the user credential via an RFID card or a smart device possessed by the user.

4. The wireless latch assembly of claim 3, wherein when the wireless transceiver detects the user credential via the RFID card or the smart device, the user credential is refreshed on the RFID card or the smart device.

5. The wireless latch assembly of claim 3, wherein when the wireless transceiver detects the user credential via the RFID card or the smart device, the user credential is stored in an audit trail.

6. The wireless latch assembly of claim 3, wherein the wireless transceiver is configured to receive a black list of credentials as a push from an administrator indicating that the credentials on the black list are no longer valid to permit access to the secure space.

7. The wireless latch assembly of claim 3, wherein the wireless transceiver is configured to receive a new plurality of credentials as a push from an administrator excluding the user credential when the user is no longer permitted access to the secure space.

8. The wireless latch assembly of claim 3, wherein the wireless transceiver is configured to communicate with a hub that services a plurality of wireless latch assemblies, the wireless transceiver being configured to receive the plurality of credentials from the hub or instructions from the hub to enable a user to unlatch the latch for access to the secure space.

9. The wireless latch assembly of claim 1, wherein the secure space is a secure room, a secure cabinet, a secure cart, or a compartment thereof, and the condition is a temperature or a humidity within the secure space.

10. The wireless latch assembly of claim 1, wherein the wireless latch assembly is capable of operating independently and the processor is further configured to perform the detecting, the comparing and the enabling steps without wireless communication with external components.

11. The wireless latch assembly of claim 1, wherein the processor is further configured to perform dual authentication by:
repeating the detecting and the comparing steps with an additional user credential, and
enabling the user to unlatch the latch for access to the secure space when it is determined that the user credential and the additional user credential are both valid.

12. A wireless latch system comprising:
a server;
a communication hub configured for communication with the server;
an administrator computer configured for communication with the communication hub; and
at least one wireless latch assembly including:
a latch configured for latching a secure space,
a display, local to the latch, configured to display information,
a sensor port positioned for coupling a sensor to the wireless latch assembly and configured for receiving a signal corresponding to a condition associated with the secure space,
a wireless transceiver configured for performing wireless communication with one or more wireless components external to the wireless latch assembly, and
a processor coupled to the display and to the wireless transceiver, the processor being configured for controlling the wireless latch;
wherein the administrator computer is configured to transmit to the server a plurality of credentials and a latch identification corresponding to the at least one wireless latch assembly, the plurality of credentials relating to access of the secure space secured by the at least one wireless latch assembly;
wherein the server is configured to store the plurality of credentials and communicate the plurality of credentials and the latch identification to the communication hub;
wherein the communication hub is configured to push the plurality of credentials to the at least one wireless latch assembly that corresponds to the latch identification;
wherein the processor of the wireless latch assembly is configured to:
display, via the display, information relating to operation of the wireless latch assembly and information relating to the condition associated with the secure space,
receive, via the wireless transceiver, the plurality of credentials,
detect, via the wireless transceiver, a user credential of the user requesting access to the secure space,
compare the user credential of the user to the plurality of credentials to determine when the user credential is valid, and
enable operation of the latch to unlock the secure space when it is determined that the user credential is valid.

13. The wireless latch system of claim 12, further comprising plural wireless latch assemblies, wherein the administrator computer is configured to transmit to the server a plurality of credentials and a latch identification corresponding to a selected wireless latch assembly, the plurality of credentials relating to access of the secure space secured by the selected wireless latch assembly;
wherein the server is configured to store the plurality of credentials and communicate the plurality of credentials and the latch identification to the communication hub; and
wherein the communication hub is configured to push the plurality of credentials to the selected wireless latch assembly.

14.-63. (canceled)
